(19) United States
(12) Patent Application Publication
(10) Pub. No.: US 2015/0124577 A1
(43) Pub. Date: May 7, 2015

(54) OPTICAL INFORMATION RECORDING MEDIUM AND OPTICAL INFORMATION RECORDING DEVICE

(71) Applicant: Panasonic Intellectual Property Management Co., Ltd., Osaka (JP)

(72) Inventors: Kiyotaka Ito, Kyoto (JP); Yasumori Hino, Nara (JP); Isao Kobayashi, Osaka (JP)

(73) Assignee: Panasonic Intellectual Property Management Co., Inc., Osaka (JP)

(21) Appl. No.: 14/394,899

(22) PCT Filed: Oct. 1, 2013
(86) PCT No.: PCT/JP2013/005847

§ 371 Date: Oct. 16, 2014

(30) Foreign Application Priority Data
Oct. 4, 2012 (JP) 2012-221890

(51) Int. Cl. G11B 7/0045

(52) U.S. Cl. CPC G11B 7/00456
USPC 369/112.23; 369/272.1

(57) ABSTRACT

When bₙₜ denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n and k denotes a maximum value of n, the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT and the length adjustment amount c_{kT} of a rear edge portion of the longest recording mark dT satisfy b_{dT}+c_{dT}>b_{kT}+c_{kT}.

### TECHNICAL FIELD

The present invention relates to an optical information recording medium that can record large capacity information by forming recording marks at high density, and an optical information recording device that records information on the optical information recording medium at high density.

### BACKGROUND ART

Optical information media are widely used as a large capacity information recording media. Technical developments to advance the capacity of optical information media has been advancing by using laser beams having shorter wavelengths and objective lenses having higher numerical apertures, such as CD, DVD and BD (Blu-Ray® disk). Lately a service called “cloud” that uses Internet-based online storage is expanding annually, with even larger capacities demanded for storages that include hard disk drives (HDDs) and flash memory.

To further increase the capacities of optical information recording media, the following developments are on-going.

To make the wavelength of a laser beam shorter, semiconductor lasers that can emit 300 nm level laser beams in the ultraviolet region have been commercialized. However light in a 300 nm or less ultraviolet range attenuates drastically in air, hence the major effect of decreasing the wavelength of a laser beam cannot be expected.

To make numerical apertures higher, on the other hand, a technique to increase the recording surface density by using a solid immersion lens (SIL), where the numerical aperture is 1 or more, has been developed. Research to increase the recording surface density, by using near-field light generated in a region smaller than the diffraction limit of light, is also in-progress.

Furthermore, developments aiming at larger capacities by making the recording surface multi-layer is on-going.

It is also possible to increase the recording density by generating shorter recording marks on the optical information recording media.

In an optical information medium, information is recorded using the lengths of the recording marks, the positions of the recording marks or the edge positions of the recording marks. Therefore when recording marks are generated on an optical recording medium, it is important to appropriately adjust the lengths of the recording marks, the positions of the recording marks or the edge position of the recording marks.

A method for generating recording marks on a conventional optical information recording medium to implement high density recording is to generate various lengths of recording marks of which front edge portions and rear edge portions are shifted by a predetermined length, so that the reproduced waveform matches with the information points (e.g. see Patent Literature 1).

FIG. 17 is a diagram depicting a relationship of recording marks generated on a conventional information recording medium and a beam spot according to Patent Literature 1.

In FIG. 17, the edge positions of the recording mark 102 are adjusted so that the information 101 for each clock channel T matches with cross-points between the reproduced signal 103, which are recording marks 102 reproduced by a beam spot 105, and a slice level 104. In this case, it is assumed that the front edge portion and the rear edge portion of the recording mark are formed in arc shapes, and when 2a denotes a track width, b denotes a length of the curved part of the front edge portion, c denotes a length of the curved part of the rear edge portion, w denotes a radius of the beam spot 105, and α denotes a constant, the average value of the front edge position is shifted forward from the switching point of the information 101 in proportion to the following Expression (1), and the average value of the rear edge position is shifted backward or forward from the switching point of the information 101 in proportion to the following Expression (2).

$$\begin{matrix} [ Math . 1 ] & \\ b exp ( - α \frac{{a}^{2}}{{w}^{2}} ) & ( 1 ) \\ [ Math . 2 ] & \\ c exp ( - α \frac{{a}^{2}}{{w}^{2}} ) & ( 2 )\end{matrix}$$

By increasing the recording density, the length of a short recording mark becomes close to the limit of the resolution, which depends on the detection system. In optical information recording media, the resolution that depends on the detection system is referred to as the optical resolution, which depends on the size of a beam spot.

Because of this resolution limit, an increase in inter-symbol interference and deterioration of the signal-to-noise ratio (SNR) become more conspicuous in a reproduced signal. As a result, in the case of a signal processing method using a slice level, decoding information from a reproduced signal is difficult.

Therefore the partial response maximum likelihood (PRML) method is normally used as the signal processing method.

The PRML method is a technique that combines a partial response (PR) method based on the generation of a known inter-symbol interference and a maximum likelihood (ML) method that selects and decodes a signal sequence having a maximum likelihood from the reproduced signals.

It is known that the decoding performance of the reproduced signals on the basis of the PRML method further improves than when the conventional slice level determination method is used.

FIG. 18 is a diagram depicting a reproduced signal in which a recording mark of a conventional optical information recording medium is reproduced. The PR method is based on the assumption that the energy at a peripheral channel clock position leaked and caused inter-symbol interference. Therefore in the case of the PR type signal processing method, as shown in FIG. 18 it is assumed that when a signal, generated by reproducing an isolated mark 201 for one channel clock (1T), is a 1T isolated signal 202, the reproduced signal 204 of the 3T recording mark 205 is a signal generated by adding the 1T isolated signal 202 corresponding to the information 203 for each channel clock. Thereby decoding by a linear signal processing method becomes possible. Here only the 3T recording mark was described, but various recording mark lengths are used depending on the modulation format of the information recording medium, and the above description is also applicable to a recording mark having a length other than 3T.

By the PR method, the length and edge positions of the recording mark are adjusted so that the reproduced signal of the recording mark becomes an addition of the 1T isolated signals 202. Thereby even if the optical recording medium includes a recording mark that is close to or smaller than the resolution of the detection system, a high density recording that allows acquiring reproduced signals with a high SNR is implemented.

However in the case of the configuration of the conventional optical information recording medium disclosed in Patent Literature 1, density can be increased only in a range where the width of a short recording mark and the width of a long recording mark roughly match, and a further increase in density is not considered.

In the case of increasing the recording density, recording marks, which are very small with respect to a beam spot, are recorded. A plurality of recording marks, which have short channel clock lengths, simultaneously exist in a beam spot.

Furthermore, the width of the recording mark may differ depending on the length of the recording mark.

Therefore if high density recording is performed that includes a plurality of recording marks that are small enough to simultaneously exist in a beam spot, or if high density recording is performed that includes recording marks that are shorter than the modulation transfer function (MTF) cut-off frequency, a difference is generated between the reproduced signal of an especially short recording mark and a signal generated by adding isolated signal, if the edge position is merely shifted by a predetermined length for all the recoding marks of different lengths and widths in prior art, and this difference causes reproduction distortion. If reproduction distortion is generated, SNR deteriorates and the information error rate increases. Therefore the conventional optical information recording media cannot implement higher density recording.

The present inventors confirmed that this problem actually occurs by a numeric calculation experiment. This numeric calculation experiment will be described later.

### CITATION LIST

### Patent Literature

Patent Literature 1: Japanese Patent Application Laid-Open No. H5-159298

### SUMMARY OF INVENTION

With the foregoing in view, it is an object of the present invention to provide an optical information recording medium and an optical information recording device that allow generating recording marks at higher density.

An optical information recording medium according to an aspect of the present invention is an optical information recording medium configured to record information by generating a plurality of recording marks having various lengths, wherein when b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n and k denotes a maximum value of n, the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT and the length adjustment amount c_{kT} of a rear edge portion of the longest recording mark dT satisfy b_{dT}+c_{dT}>b_{kT}+c_{kT}.

According to this invention, the length adjustment amount b_{dT} of the front edge portion and the length adjustment amount c_{dT} of the rear edge portion of the shortest recording mark dT becomes greater than the length adjustment amount b_{kT} of the front edge portion and the length adjustment amount c_{kT} of the rear edge portion of the longest recording mark dT, therefore a reproduced signal maintaining an approximate linearity can be acquired, and the reproduced signal can have high SNR with minimum reproduction distortion. As a result, the recording marks can be generated at higher density.

The object, features and advantages of the present invention will be more apparent from the following detailed description and the accompanying drawings.

### BRIEF DESCRIPTION OF DRAWINGS

FIG. 1 is a diagram depicting an example of recording marks generated on an optical information recording medium.

FIG. 2 is a diagram for explaining processing to reproduce recording marks on the optical information recording medium.

FIG. 3 is a diagram for explaining a principle of a numeric calculation experiment of the optical information recording medium.

FIG. 4 is a diagram for explaining an example of a method for generating an isolated signal.

FIG. 5 shows the result of comparing reproduced signals and added signals of 2T to 8T recording marks when the 1T length is 75.0 nm.

FIG. 6 shows the result of comparing reproduced signals and added signals of 2T to 8T recording marks when the 1T length is 55.0 nm.

FIG. 7 shows the result of comparing reproduced signals and added signals of 2T to 8T recording marks when the 1T length is 37.5 nm.

FIG. 8 shows the result of comparing reproduced signals and added signals of 2T to 8T recording marks when the 1T length is 27.5 nm.

FIG. 9 shows a relationship of a channel clock length and a recording mark length adjustment amount when 1T length is 55.0 nm, 37.5 nm and 27.5 nm in the present embodiment.

FIG. 10 is a diagram depicting recording marks having various lengths, which are generated on an optical information recording medium according to Embodiment 1 of the present invention.

FIG. 11 is a diagram depicting a configuration of an optical information recording medium according to Embodiment 2 of the present invention.

FIG. 12 is a diagram depicting a configuration of an optical information recording/reproducing device according to Embodiment 3 of the present invention.

FIG. 13 is an enlarged view of a part of the recording surface of the optical information recording medium.

FIG. 14 is a diagram for explaining the lengths of the recording marks generated on the optical information recording medium according to Embodiment 3 of the present invention.

FIG. 15 is a diagram depicting an example of a recording pulse for binary data.

FIG. 16A shows an example of a pulse waveform when the recording pulse is an L-type pulse, FIG. 16B shows an example of a pulse waveform when the recording pulse is a castle-type pulse, and FIG. 16C shows an example of a pulse waveform when the recording pulse is a multi-pulse.

FIG. 17 is a diagram depicting a relationship of recording marks generated on a conventional optical information recording medium and a beam spot.

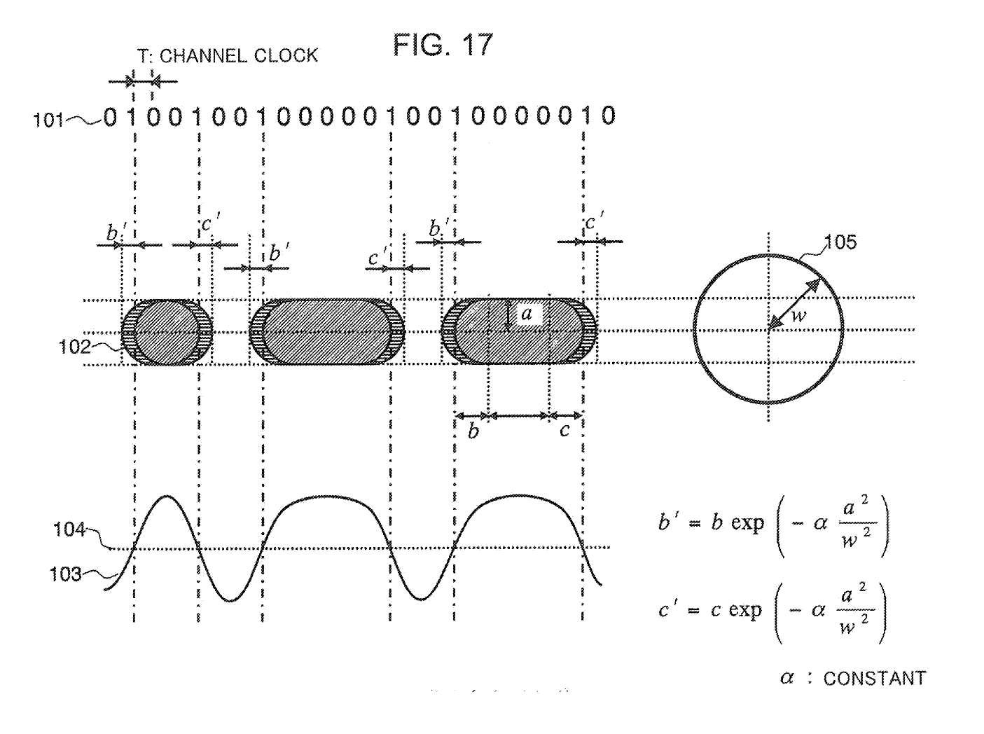

FIG. 18 is a diagram depicting a reproduced signal to reproduce a recording mark according to the conventional optical information recording medium.

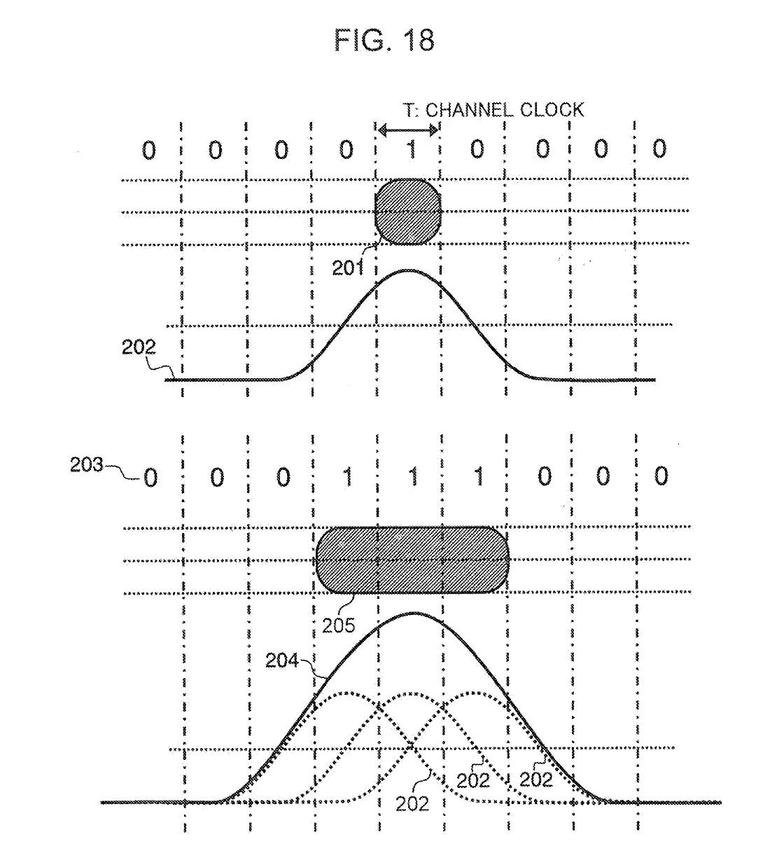

### DESCRIPTION OF EMBODIMENTS

The numeric calculation experiment on the length of the recording marks generated on an optical information recording medium, and the reproduced signals will be described.

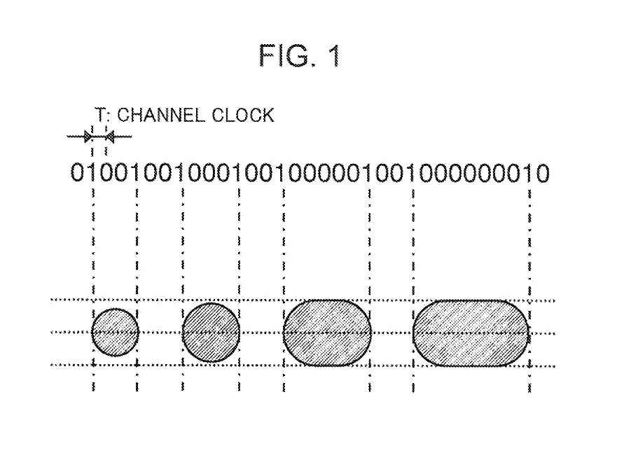

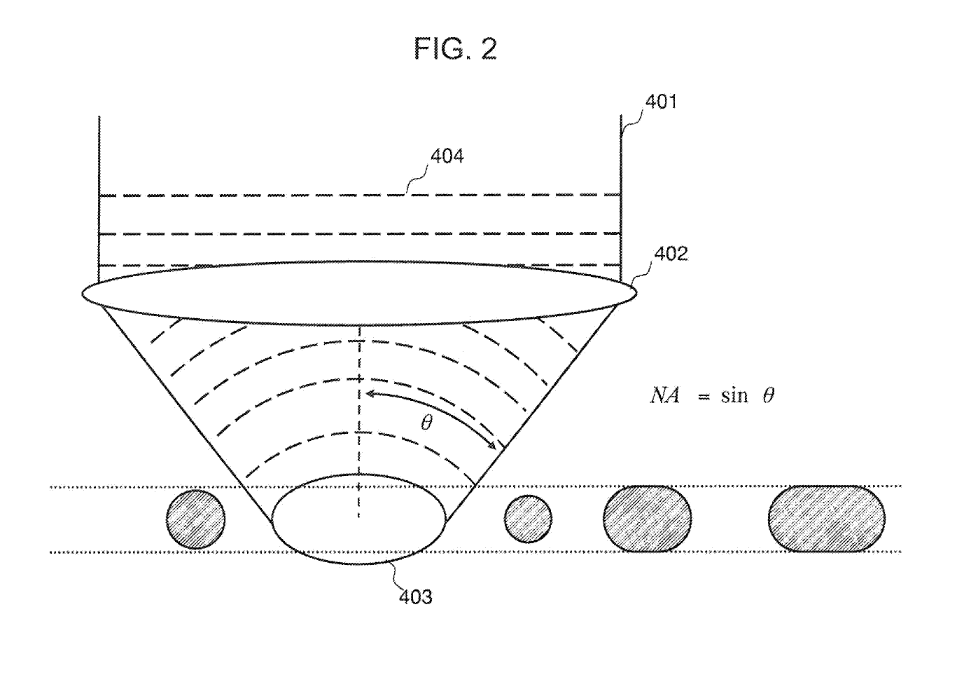

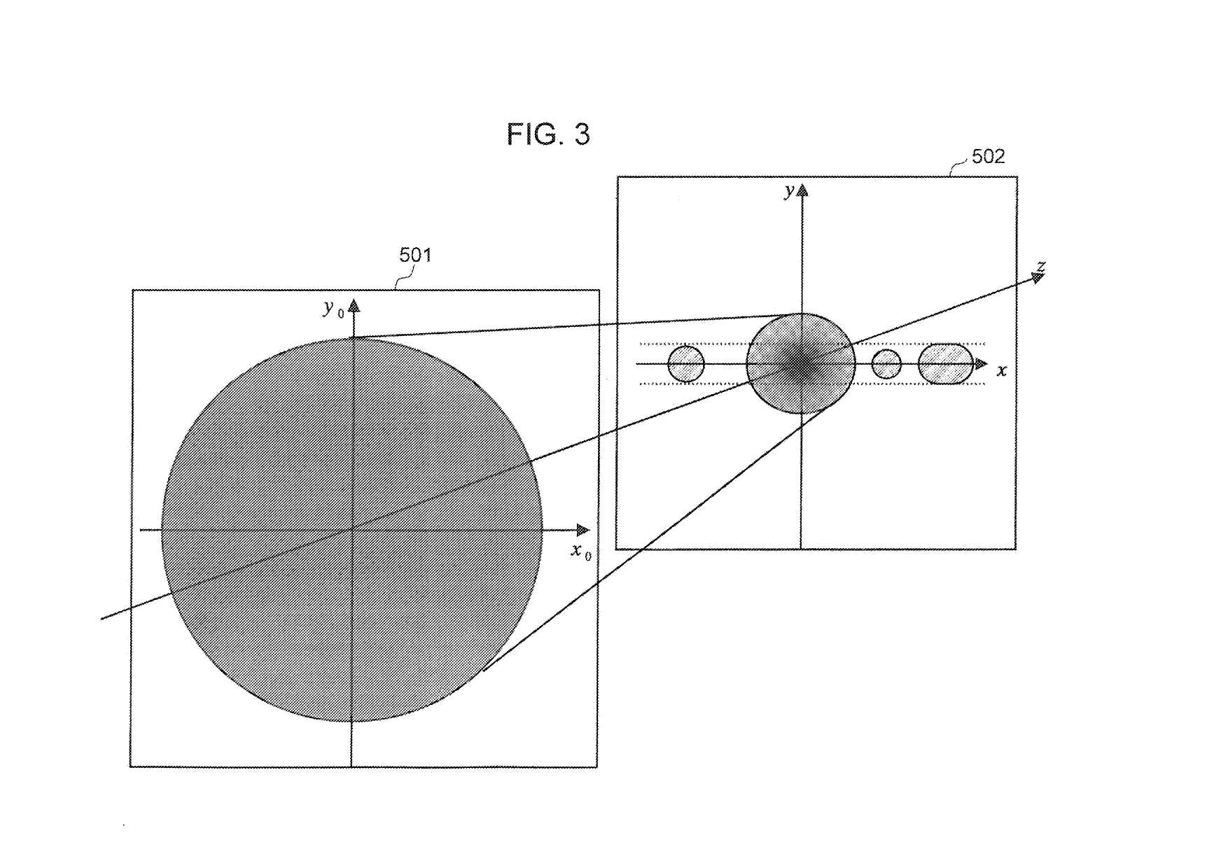

FIG. 1 is a diagram depicting an example of recording marks generated on the optical information recording medium. FIG. 2 is a diagram for explaining processing to reproduce recording marks on the optical information recording medium. FIG. 3 is a diagram for explaining a principle of a numeric calculation experiment of the optical information recording medium.

As shown in FIG. 1, the width of a recording mark is different depending on the length of the recording mark. A beam spot 403 is formed on the optical information recording medium by a lens 402 condensing the laser beam 401 on a recording surface, as shown in FIG. 2. In FIG. 2, the broken line indicates a wave surface 404 of the laser beam 401, and an angle θ indicates a maximum angle with respect to the optical axis. The angle θ depends on the numerical aperture of the lens 402.

An intensity distribution u (x,y) of the beam spot 403 can be determined using the Fresnel diffraction integration shown in the following Expression (3), considering an aperture surface 501 which corresponds to the lens 402, and a beam condensing surface 502 which corresponds to the recording surface, as shown in FIG. 3.

$$\begin{matrix} [ Math . 3 ] & \\ u ( x , y ) = \frac{1}{jλ f} exp ( j \frac{2 π}{λ} f ) \int \int a ( {x}_{0} , {y}_{0} ) exp ( j \frac{π}{λ f} ( {( x - {x}_{0} )}^{2} + {( y - {y}_{0} )}^{2} ) ) d {x}_{0} d {y}_{0} & ( 3 )\end{matrix}$$

In Expression (3), λ denotes a wavelength of the laser beam 401, and f denotes a focal length, which is a distance between the aperture surface 501 and the beam condensing surface 502.

In the focal length of the lens, Expression (3) can be converted into a form similar to an approximation of a Fraunhofer diffraction, and the integral terms can be regarded as a Fourier transform. As a result, Expression (3) can be approximated by Expression (4).

$$\begin{matrix} [ Math . 4 ] & \\ u ( x , y ) = \frac{1}{jλ f} exp j ( \frac{2 π}{λ} ( f + \frac{( {x}^{2} + {y}^{2} )}{2 f} ) ) \int \int a ( {x}_{0} , {y}_{0} ) exp ( j \frac{π}{λ f} ( {x}_{0}^{2} + {y}_{0}^{2} ) ) exp ( j \frac{π}{λ f} ( 2 {x}_{0} x + 2 {y}_{0} y ) ) d {x}_{0} d {y}_{0} \approx \frac{1}{jλ f} exp j ( \frac{2 π}{λ} ( f + \frac{( {x}^{2} + {y}^{2} )}{2 f} ) ) \int \int a ( {x}_{0} , {y}_{0} ) exp ( j2π ( {x}_{0} \frac{x}{λ f} + {y}_{0} \frac{y}{λ f} ) ) d {x}_{0} d {y}_{0} \approx \frac{1}{jλ f} exp j ( \frac{2 π}{λ} ( f + \frac{( {x}^{2} + {y}^{2} )}{2 f} ) ) F [ a ( {x}_{0} , {y}_{0} ) ] & ( 4 )\end{matrix}$$

As Expression (4) shows, the intensity distribution of the beam spot 403 on the recording surface is given by Fourier-transforming the product of the intensity distribution of the laser beam 401, before transmitting through the lens 402, and the aperture distribution of the lens 402. Therefore in the numeric calculation experiment, if A(x₀, y₀) denotes the intensity distribution of the laser beam 401, I(x₀, y₀) denotes the aperture distribution of the lens 402, and R(x,y) denotes the reflectance distribution between the recording mark portion and the non-recording mark portion of the recording surface, then the light intensity distribution I(xᵣ,yᵣ) acquired when the laser beam reflected from the optical information recording medium transmitted through the lens is given by Expression (5).

[Math. 5]

i(xᵣ,yᵣ)=F[R(x,y)F[A(x₀,y₀)l(x₀,y₀)]] (5)

The integrated value of the light intensity distribution I(xᵣ,yᵣ) acquired by Expression (5) becomes a reproduced signal Sig. The reproduced signal Sig is given by the following Expression (6).

[Math. 6]

Sig=α∫∫I(xᵣ,yᵣ)dxᵣ,dyᵣ (6)

In Expression (6), α denotes a coefficient that includes the shading of the optical system, the light receiving sensitivity of a photodetector and a coefficient of an amplifier.

A concrete result of the numerical calculation experiment is shown below. Generally a 1T length that corresponds to a channel block of a BD is 74.5 nm. The reproduced signals of the 2T to 8T recording marks generated by shifting the edge positions by a predetermined length, when the 1T length is 75.0 nm, 55.0 nm, 37.5 nm and 27.5 nm, for example, were determined by numeric calculation.

The shape of a recording mark here is roughly an ellipse, and the shape of the front edge portion and the rear edge portion thereof is an arc of which diameter is the width of the recording mark. If the length of the recording mark is smaller than the width, the recording mark becomes a circle of which diameter is the length. The length of a recording mark refers to the size of the recording mark in the direction along the track, and the width of a recording mark refers to the size of the recording mark in the radius direction. Generally information is recorded on the optical information recording medium by heat generated by absorbing the condensed laser beam. The laser beam intensity distribution is circular, hence the shape of the edge portions of a generated recording mark becomes roughly an arc. The shape of a recording mark of which length is short becomes circular.

The track pitch is 317.5 nm which is approximately the same as a BD (approx. 320 nm), and the groove width is 158.75 nm, which is half that of the track pitch. The width of the recording mark having a long length is 158. 75 nm, which is the same as the groove width.

As for the values related to the beam spot, the wavelength λ of the laser beam is 405 nm, and the numerical aperture NA of the lens is 0.85. In this case, the diameter of the beam spot is normally in the range where the peak value of the laser beam intensity is 1/e². The beam spot diameter is 0.82×(NA/λ)≅390 nm. If the channel clock length is 390 nm>3×nT, then an area where the nT space exists between the nT recording marks comes within the beam spot diameter.

The amplitude of a reproduced signal, when a recording mark is reproduced using a laser beam, decreases as the recording mark becomes shorter, and reaches zero at the optical resolution limit. The inverse number of a cycle period of the recording mark and the space corresponding to the same channel clock length is called the “spatial frequency”. The transfer function of the spatial frequency is called the optical transfer function (OTF). The function that indicates the amplitude dependency of the OTF, with respect to the spatial frequency, is called the modulation transfer function (MTF). In this case, if the channel clock length of the recording mark that is recorded here is P and x=λ/(4×P×NA), then MTF (x) can be expressed by an approximation function of MTF (x)=(2/π) (arccos (x)−x (1−x²)^{1/2}). The signal amplitude indicated by MTF decreases approximately linearly as the spatial frequency increases. The critical frequency (x=1) of reproduction when the signal amplitude is zero is called the “MTF cut-off frequency”, and P_{cutoff}=λ/(4×NA). If the wavelength λ is 405 nm and the NA is 0.85, then P_{cutoff} is approximately 119 nm.

In other words, when λ denotes the wavelength of the laser beam for reading information from the optical information recording medium and NA denotes a numerical aperture for condensing the laser beam on the optical information recording medium, then the plurality of recording marks include recording marks shorter than λ/(4×NA).

Here the intensity distribution A(x₀,y₀) is a Guassian distribution. The aperture distribution I(x₀,y₀) is a distribution where an area inside the lens radius is “1”, and an area outside the lens radius is “0”. The reflectance distribution R(x,y) of the recording surface is calculated based on the assumption that the reflectance of the non-recording mark portion is 20%, and the reflectance of the recording mark portion is 6%.

If the signals reproducing the recording marks having various lengths calculated under the above conditions is close to a signal generated by adding 1T isolated signals, then this means that approximate linearity is maintained, and a reproduced signal having high SNR can be acquired by the PR method.

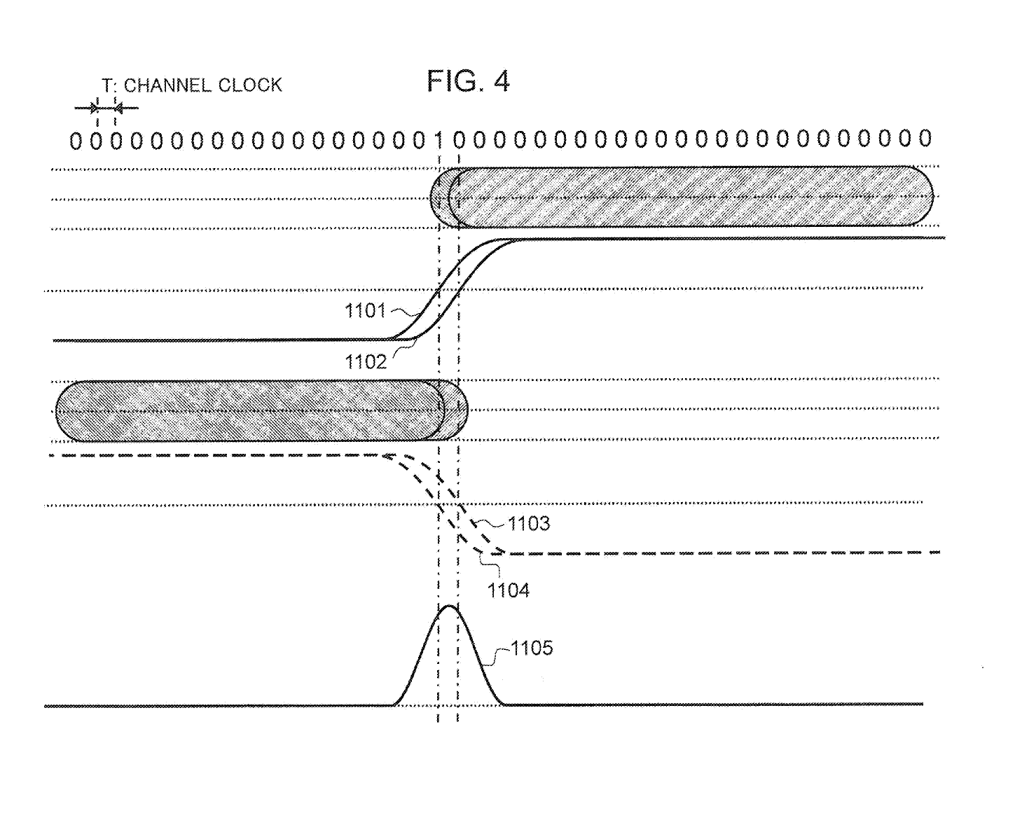

Here a method for determining a 1T isolated signal has been contrived. FIG. 4 is a diagram for explaining an example of a method for generating an isolated signal. Conventionally a signal, which is generated by reproducing an isolated mark for 1 channel clock length, is added. In FIG. 4, however, the difference between a front edge portion reproduced signal 1101 generated by reproducing the front edge portion of a long recording mark, which is influenced less by inter-symbol interference, and a front edge portion 1T shift signal 1102 generated by shifting the front edge portion reproduced signal 1101 by 1 channel clock length, and the difference between a rear edge portion reproduced signal 1103 generated by reproducing a rear edge portion of a long recording mark, which is influenced less by inter-symbol interference, and a rear edge portion 1T shift signal 1104 generated by shifting the rear edge portion reproduced signal 1103 by 1 channel clock length, are averaged, and the result is regarded as the 1T isolated signal 1105.

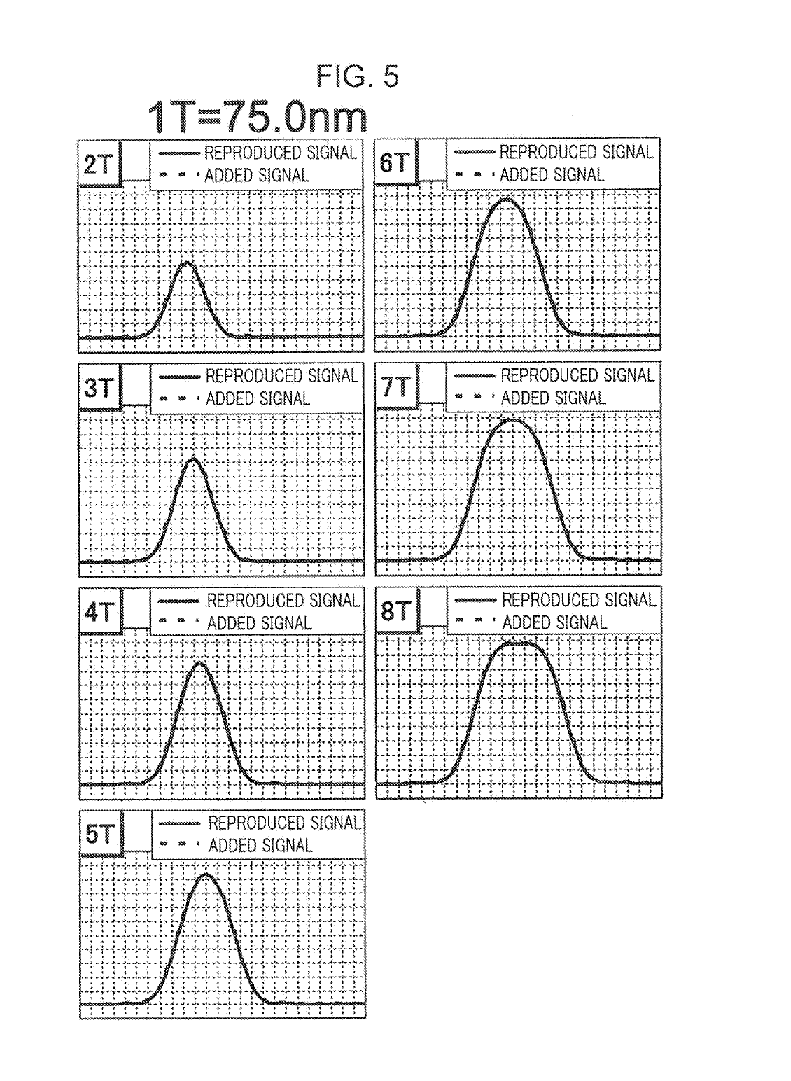

FIG. 5 to FIG. 8 show the result of comparing the signals generated by adding the 1T isolated signal determined like this for a corresponding channel clock length and the reproduced signal acquired by the numeric calculation experiment with shifting the edge position of the recording mark by a predetermined length. In FIG. 5 to FIG. 8, the abscissa indicates time at each channel clock, and the ordinate indicates a signal level of a reproduced signal and the added signal.

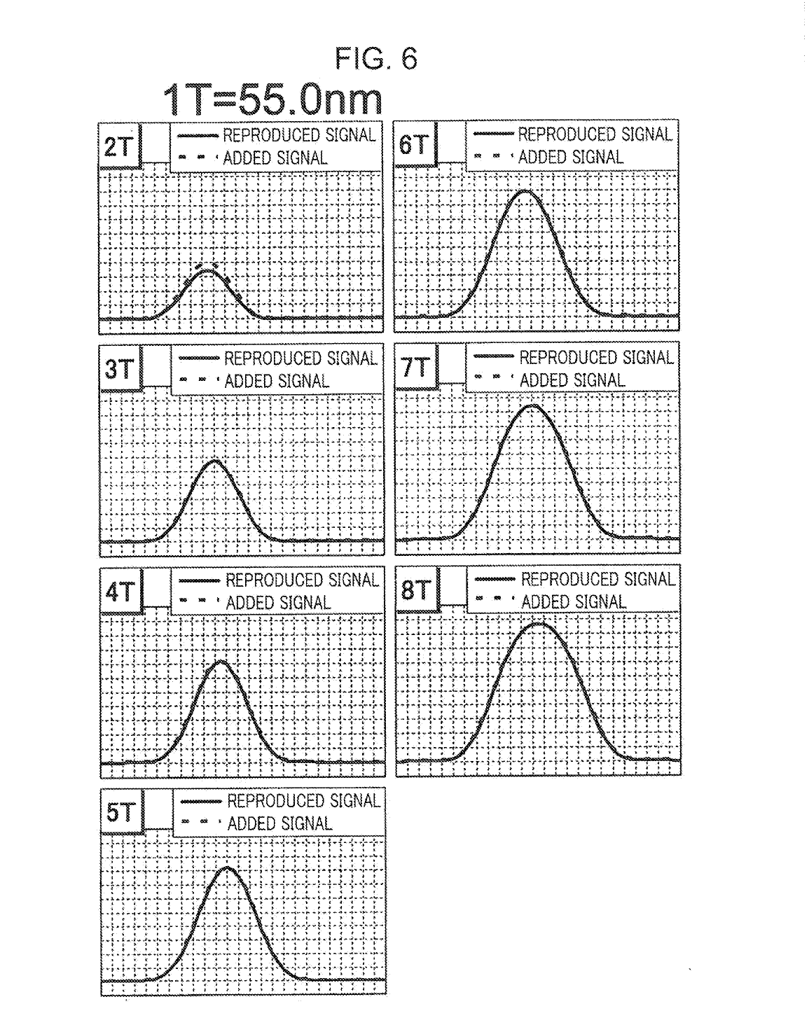

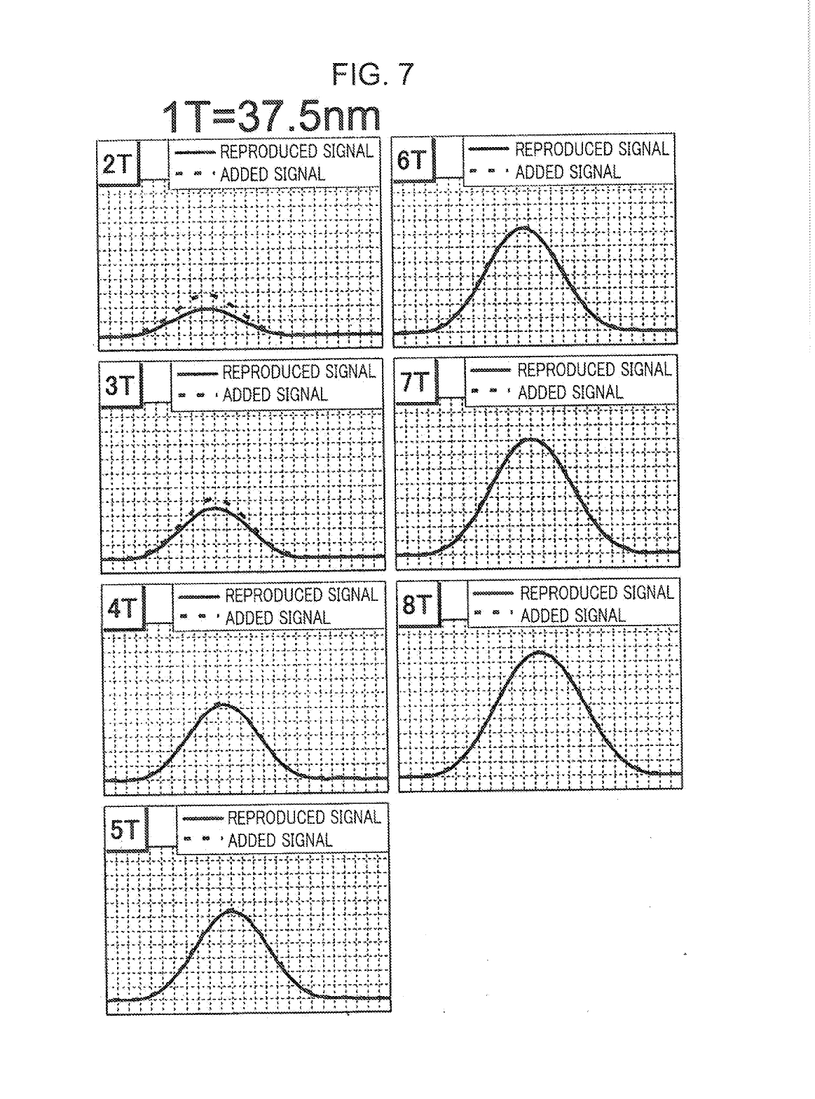

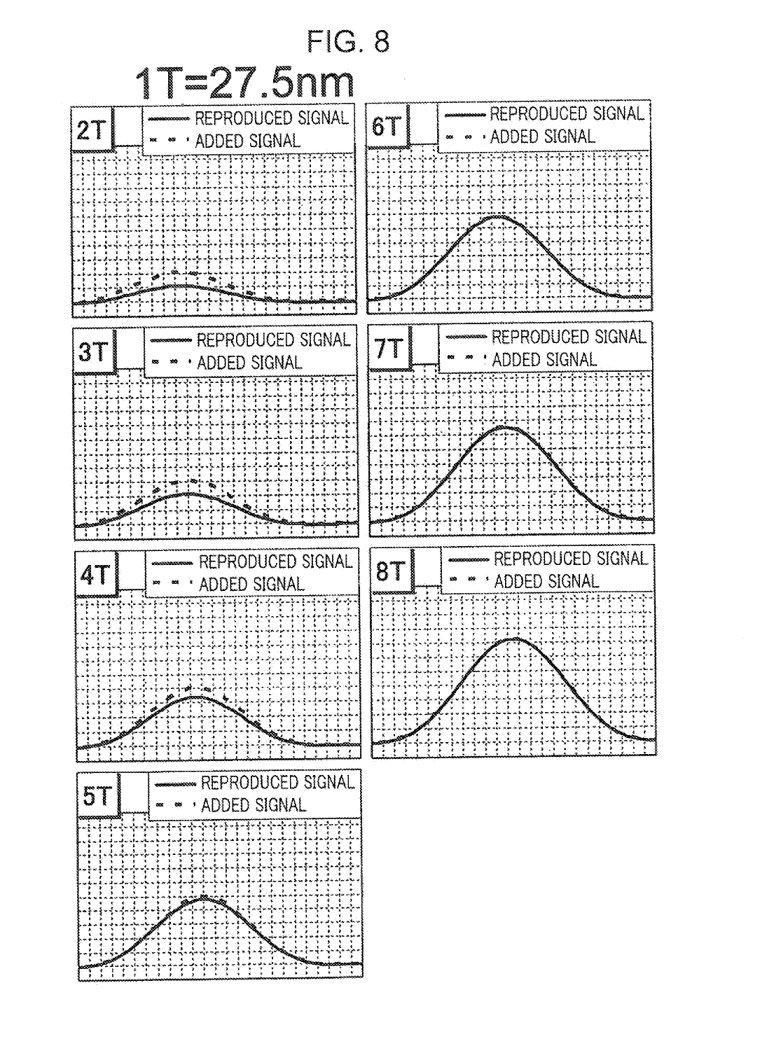

FIG. 5 shows the result of comparing the reproduced signals and added signals of the 2T to 8T recording marks when the 1T length is 75.0 nm. FIG. 6 shows the result of comparing the reproduced signals and added signals of the 2T to 8T recording marks when the 1T length is 55.0 nm. FIG. 7 shows the result of comparing the reproduced signals and added signals of the 2T to 8T recording marks when the 1T length is 37.5 nm. And FIG. 8 shows the result of comparing the reproduced signals and added signals of the 2T to 8T recording marks when the 1T length is 27.5 nm.

As shown in FIG. 5, when the 1T length is 75.0 nm, the reproduced signals and added signals are approximately matched in all the 2T to 8T lengths. As shown in FIG. 6, when the 1T length is 55.0 nm, a difference is generated between the reproduced signal and added signal in 2T (110.0 nm). Then as shown in FIG. 7, when the 1T length is 37.5 nm, a difference is generated between the reproduced signal and added signal in 2T (75.0 nm) and 3T (112.5 nm). Finally as shown in FIG. 8, when the 1T length is 27.5 nm, a difference is generated between the reproduced signal and added signal from 2T (55.0 nm) to 4T (110.0 nm). This result shows that a difference is generated between the reproduced signal and added signal in a recording mark smaller than P_{cutoff}, if the edge position is merely shifted by a predetermined length.

The present inventors also discovered by the numeric calculation experiment that the shift from the added signal increases as the 1T length and recording mark length decrease. This indicates that if linear reproduced signal processing is performed on a recording mark of which the 1T length and the recording mark length are short, then the shift amount increases, and the SNR of the reproduced signal worsens as the recording mark length becomes shorter.

Here the recording mark length, at which the difference between the reproduced signals of the 2T and 8T recording marks and the signals generated by adding the 1T isolated signals become the minimum, was derived using the examples of 1T lengths 55.0 nm, 37.5 nm and 27.5 nm.

The wavelength of the laser beam, the numerical aperture of the lens, the shape of the recording mark, the track pitch, the groove width and the width of the long recording mark are subject to the same conditions as the numerical calculation experiment described above.

The intensity distribution A(x₀,y₀) of the laser beam is a Gaussian distribution. The aperture distribution I(x₀,y₀) of the lens is a distribution where an area inside the lens radius is “1” and an area outside the lens radius is “0”. The reflectance distribution R(x,y) of the recording surface is calculated based on the assumption that the reflectance of the non-recording mark portion is 20%, and the reflectance of the recording mark portion is 6%.

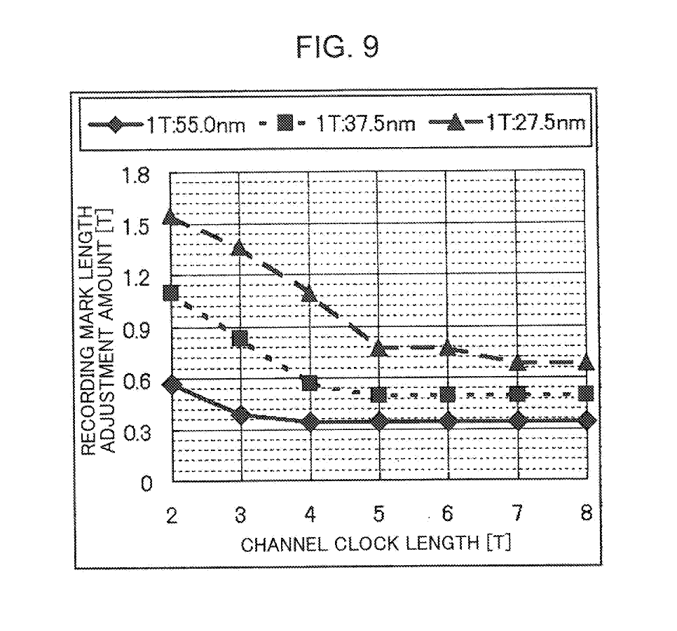

The result of calculation under the above conditions is shown in FIG. 9. FIG. 9 shows a relationship of a channel clock length and a recording mark length adjustment amount when the 1T length is 55.0 nm, 37.5 nm and 27.5 nm according to the present embodiment. In FIG. 9, the abscissa indicates the channel clock length nT (n: integer), and the ordinate indicates the adjustment amount of the recording mark length, which is adjusted to minimize the difference between the signal generated by adding the 1T isolated signals for the n channel clocks and the reproduced signal determined by the numeric calculation. When the 1T length is 55.0 nm, the adjustment amount of the recording marks, of which channel clock length is 4T or more, are approximately constant, and if the adjustment amount is at this level, the difference between the reproduced signal and the added signal is at the minimum. However the adjustment amount of each recording mark, of which channel clock length is 2T and 3T, is not constant. The adjustment amount for 3T may be approximately the same as the adjustment amount of 4T or more if the influence of SNR is small. When the 1T length is shorter than 55.0 nm, a number of recording marks of which adjustment amount is not constant increases. In some cases, an adjustment amount exceeding 1T is necessary, according to the numeric calculation experiment.

Thereby the present inventors clarified the relationship of each recording mark length, by which a reproduced signal with little deviation and high SNR is acquired, for all the recording marks having different lengths and widths when high density recording is performed, including the recording marks which are so small that a plurality of recording marks can simultaneously exist in a beam spot.

Embodiments of the present invention will now be described with reference to the drawings. The following embodiments are examples of carrying out the invention, and are not intended to limit the technical scope of the invention.

### Embodiment 1

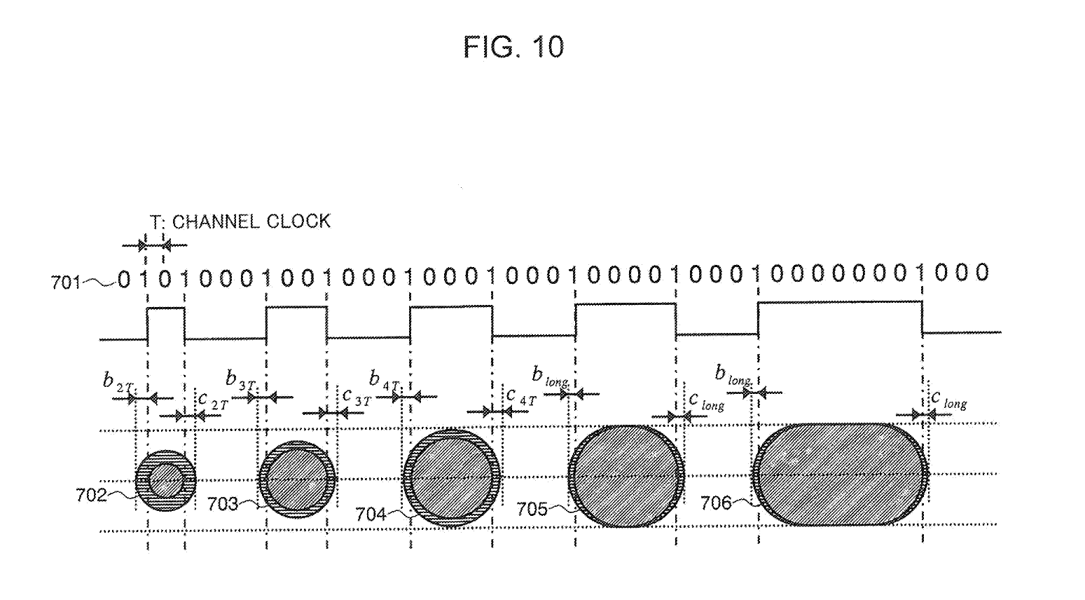

FIG. 10 is a diagram depicting the recording marks having various lengths, which are generated on an optical information recording medium according to Embodiment 1 of the present invention.

In FIG. 10, information 701 is binary data for each channel clock T, and is a non-return to zero inverted (NRZI) signal of which edge positions of a recording mark are “1”. The length nT (e.g. n=an integer in a 2 to 8 range) corresponding to the channel clock length from “1” to “1” in the information 701 becomes a reference length of a recording mark or a non-recording mark (space). In a recording mark of which reference length of the recording mark is greater than the width of the recording mark (e.g. 5T mark 705, 6T mark (not illustrated), 7T mark (not illustrated) and 8T mark 706), the adjustment amount of the front edge portion from the reference length is b_{long}, and the adjustment amount of the rear edge portion from the reference length is c_{long}.

On the other hand, in a recording mark of which reference length of the recording mark is smaller than the width of the recording mark (e.g. 2T mark 702, 3T mark 703 and 4T mark 704), the adjustment amount of the front edge portion of the 2T mark from the reference length is b_{2T}, the adjustment amount of the rear edge portion of the 2T mark from the reference length is c_{2T}, the adjustment amount of the front edge portion of the 3T mark from the reference length is b_{3T}, the adjustment amount of the rear edge portion of the 3T mark from the reference length is c_{3T}, the adjustment amount of the front edge portion of the 4T mark from the reference length is b_{4T}, and the adjustment amount of the rear edge portion of the 4T mark from the reference length is c_{4T}.

At this time, the adjustment amount of each recording mark satisfies the relationship of the following Expression (7).

b_{2T}+c_{2T}>b_{3T}+c_{3T}>b_{4T}+c_{4T}≧b_{long}+c_{long} (7)

By increasing the adjustment amount of a recording mark as the length of the recording mark is shorter, a reproduced signal which maintains approximate linearity can be acquired in reproduction.

This generation of recording marks on the optical information recording medium using the adjustment amount can be performed roughly in a same way when pre-pits are generated and read only memory (ROM) is created at the factory, and when the user of the optical information recording medium generates recording marks to record the user data.

When b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n and k denotes a maximum value of n, the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT and the length adjustment amount c_{kT} of a rear edge portion of the longest recording mark dT satisfy b_{dT}+c_{dT}>b_{kT}+c_{kT}.

When x denotes an integer in the d to k−2 range, y denotes an integer in the d+1 to k−1 range, and x<y, the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T and the length adjustment amount c_{(x+1)T} of a rear edge portion of the recording mark (x+1)T satisfy b_{xT}+c_{xT}≧b_{(x+1)T}+c_{(x+1)T}, and the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT}≧b_{(y+1)T}+c_{(y+1)T}.

According to this configuration, the adjustment amount of the length of the recording mark generated on the optical information recording medium is increased as the length of the recording mark is shorter, therefore the reproduced signal that maintains approximate linearity can be acquired in reproduction, and high density recording, in which reproduced signals with high SNR are acquired, can be implemented.

In this embodiment, the NRZI signal is used as a signal that indicates the binary data, but binary data in other formats, such as a non-return to zero (NRZ) signal, may be used.

In this embodiment, information on the recording mark positions and the space positions are expressed by binary data, but the present invention is not limited to this. Multi-value data at least binary data—may be used. If the information is expressed by multi-value data, the information recorded by generating the recording marks may be converted into multi-value data by using a plurality of recording mark widths, or by changing the reflectance change amount, or by controlling the edge portions of the recording marks by using a resolution that is finer than 1T. Further, the information may be converted into multi-value data by phase modulation, where the recording mark generation position is modulated in the depth direction, that is, vertical to the light irradiation direction, and is then recorded.

In this embodiment, the reference length of 4T or smaller marks is smaller than the recording mark width, but the present invention is not limited to this. For example, at least one recording mark is required, of which reference length is smaller than the width of the recording mark.

In this embodiment, when the reference length of a recording mark is longer than the width of the recording mark, that width is always the same for such marks, but the present invention is not limited to this. For example, if there are a plurality of widths of recording marks of which reference length is longer than the width of the respective recording marks, an average value of the plurality of widths of the recording marks may be regarded as the width of the recording marks.

In this embodiment, each length of the recording marks and the spaces is 2T to 8T, but the present invention is not limited to this. The shortest recording mark length may be longer than 2T, such as 3T or 4T. Further, the longest recording mark length may be 8T or less, or 8T or more.

In this embodiment, recording marks having a same length are generated for each channel clock length, but the present invention is not limited to this. For example, when the space between recording marks is very small, inter-symbol interference occurs. To eliminate the influence of the inter-symbol interference, the adjustment amount of a recording mark may be changed depending on the lengths of the spaces before and after the recording mark, even if the channel clock length is the same.

### Embodiment 2

As described in Embodiment 1, an optical information recording medium of Embodiment 2 of the present invention stores recording parameters for generating recording marks, of which adjustment amount from the reference length increases as the length of the recording mark decreases, in the control information storage portion.

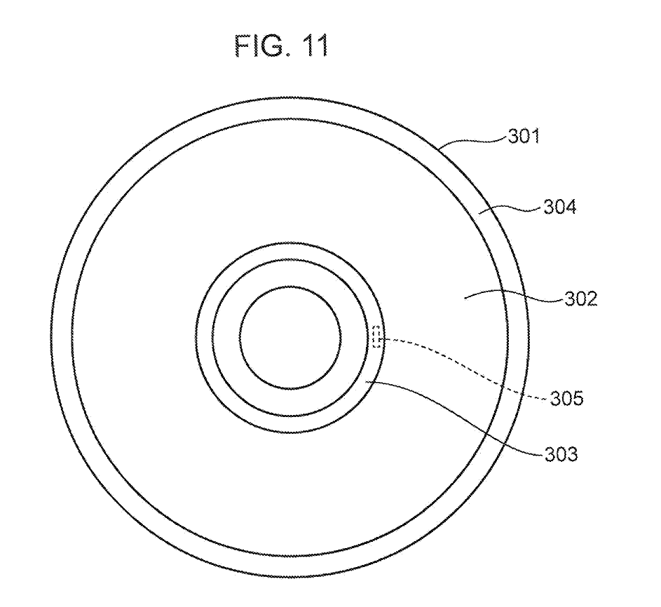

FIG. 11 is a diagram depicting a configuration of the optical information recording medium according to Embodiment 2 of the present invention.

The optical information recording medium 301 shown in FIG. 11 includes a user area 302, an inner circumference side control area 303, and an outer circumference side control area 304.

User data is recorded in the user area 302. The inner circumference side control area 303 is created in the inner circumference side of the user area 302, where management information, physical characteristic information or the like of the optical information recording medium 301 are recorded using the recording marks. The outer circumference side control area 304 is created on the outer circumference side of the user area 302, where management information, physical characteristic information or the like of the optical information recording medium 301 are recorded using the recording marks, just like the inner circumference side control area 303.

The inner circumference side control area 303 includes a control information storage portion 305. The control information storage portion 305 stores recording parameters for generating recording marks. The recording parameters are recorded as pre-information when the optical information recording medium is manufactured at factory.

When b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n, and k denotes a maximum value of n, the recording parameters includes the recording parameters for generating the recording marks in which the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT, and the length adjustment amount c_{kT} of a rear edge portion of the longest recording mark dT satisfy b_{dT}+c_{dT}>b_{kT}+c_{kT}.

When x denotes an integer in the d to k−2 range, y denotes an integer in the d+1 to k−1 range, and x<y, the recording parameters include the recording parameters for generating the recording marks in which the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T, and the length adjustment amount c_{(x+1)T} of a rear edge portion of the recording mark (x+1)T satisfy b_{xT}+c_{XT}>b_{(x+1)T}+c_{(x+1)T}, and the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT}≧b_{(y+1)T}+c_{(y+1)T}.

According to this configuration, recording marks are generated at appropriate lengths on the optical information recording medium 301, even if the optical information recording medium 301 is mounted onto different optical information recording/reproducing devices, therefore the reproduced signal that maintains approximate linearity can be acquired, and high density recording in which reproduced signal with high SNR are acquired can be implemented.

In this embodiment, the recording parameters are recorded in a control information storage portion 305 of the optical information recording medium 301 as pre-information when the optical information recording medium is manufactured at the factory, but the present invention is not limited to this. For example, regardless of the presence of pre-information, the optical information recording/reproducing device which performs the recording operation may record the recording parameters in the control information storage portion 305 of the optical information recording medium 301. Alternatively, regardless of the presence of the control information storage portion, the recording parameters may be recorded as secondary information of the address information of the optical information recording medium, whereby a similar effect can be acquired.

In this embodiment, recording marks having a same length are generated for each channel clock length, but the present invention is not limited to this. For example, when the space between the recording marks is very small, inter-symbol interference occurs. To eliminate the influence of the inter-symbol interference, recording parameters, in which the adjustment amount of a recording mark may be different depending on the length of the spaces before and after the recording mark, may be recorded in the control information storage portion 305, even if the channel clock length is the same.

In this embodiment, the inner circumference side control area 303 includes the control information storage portion 305, but the present invention is not limited to this, and the outer circumference side control area 304 or the user area 302 may include the control information storage portion 305.

In this embodiment, the optical information recording medium 301 includes both the inner circumference side control area 303 and the outer circumference side control area 304, but the optical information recording medium may include only one of the inner circumference side control area 303 and the outer circumference side control area 304.

### Embodiment 3

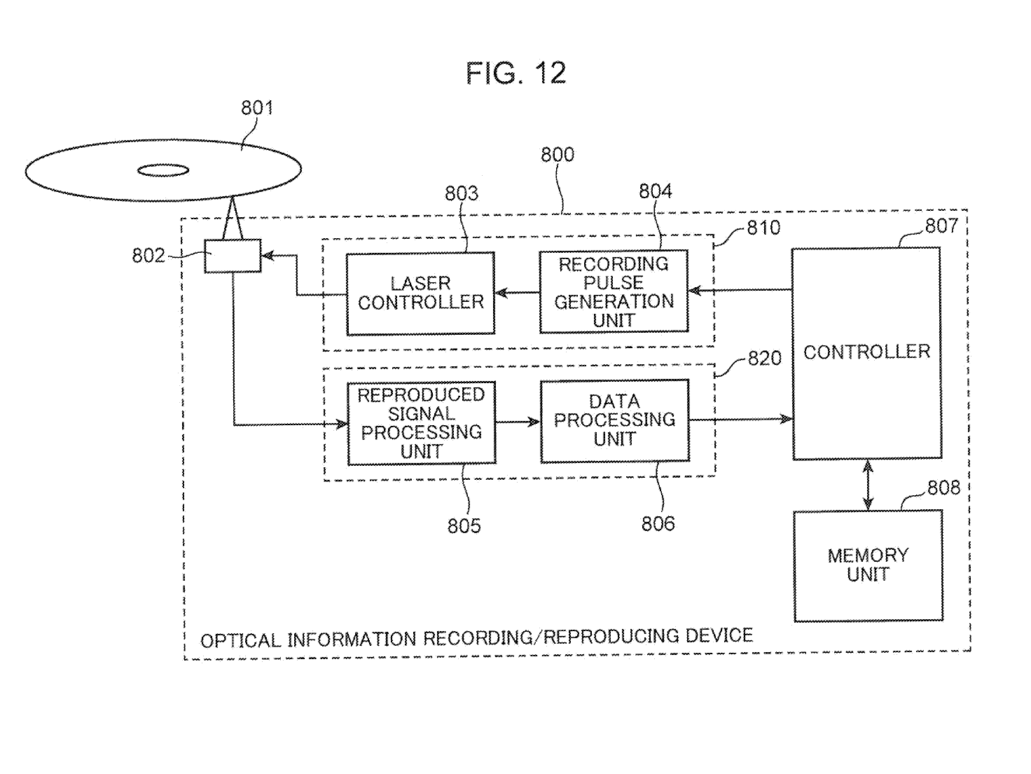

FIG. 12 is a diagram depicting a configuration of an optical information recording/reproducing device according to Embodiment 3 of the present invention.

An optical information recording/reproducing device 800 reproduces information from a mounted or inserted optical information recording medium 801, or records information on the optical information recording medium 801. The optical information recording/reproducing device 800 includes an optical head unit 802, a recording unit 810, a reproducing unit 820, a controller 807, and a memory unit 808. The optical information recording/reproducing device 800 corresponds to an example of the optical information recording device.

The optical head unit 802 includes a light source that emits a laser beam, and a lens that condenses the laser beam onto the recording surface of the optical information recording medium 801.

The recording unit 810 generates recording marks on the optical information recording medium 801. The recording unit 810 includes a laser controller 803 and a recording pulse generation unit 804.

When b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n and k denotes a maximum value of n, the recording unit 810 generates the recording marks in which the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT and the length adjustment amount c_{kT} of a rear edge portion of the longest recording mark dT satisfy b_{dT}+c_{dT}>b_{kT}+c_{kT}.

The reproducing unit 820 includes a reproduced signal processing unit 805 and a data processing unit 806.

The reproducing unit 820 reproduces recording parameters for generating recording marks on the optical information recording medium 801 from the optical information recording medium 801. The recording unit 810 generates the recording marks on the optical information recording medium 801 using the recording parameters reproduced by the reproducing unit 820.

First the reproducing operation of the optical information recording/reproducing device 800 will be described. The optical head unit 802 condenses the laser beam transmitted through the object lens onto the recording surface of the optical information recording medium 801, receives the reflected light thereof, and generates an analog reproduced signal that indicates the information recorded on the optical information recording medium 801. The analog reproduced signal reproduced by the optical information recording medium 801 is processed by the reproduced signal processing unit 805. The reproduced signal processing unit 805 outputs a binary signal, generated by binarizing the analog reproduced signal, to the data processing unit 806. The data processing unit 806 generates reproducing data from the received binary signal, and transfers the data to the controller 807.

The recording operation of the optical information recording/reproducing device 800 will be described next. The controller 807 outputs the recording data and the recording pulse parameters (recording parameters) to the recording pulse generation unit 804. The recording pulse parameters (recording parameters) have been recorded in the control information storage portion of the optical information recording medium 801, and are acquired by reproducing the data in the control information storage portion of the optical information recording medium 801. The recording pulse parameters include parameters on the laser emission power and laser emission time corresponding to the adjustment amount for each recording mark length. The recording pulse generation unit 804 generates the recording signal based on the received recording data and the recording pulse parameters. The recording pulse generation unit 804 outputs the generated recording signal to the laser controller 803. Based on the received recording signal, the laser controller 803 controls the emission of the laser light source included in the optical head unit 802, and generates the recording marks on the optical information recording medium 801. Thereby the information is recorded on the optical information recording medium 801.

In this embodiment, the wavelength of the laser beam emitted from the laser light source included in the optical head unit 802 is 405 nm, and the numerical aperture of the objective lens is 0.85.

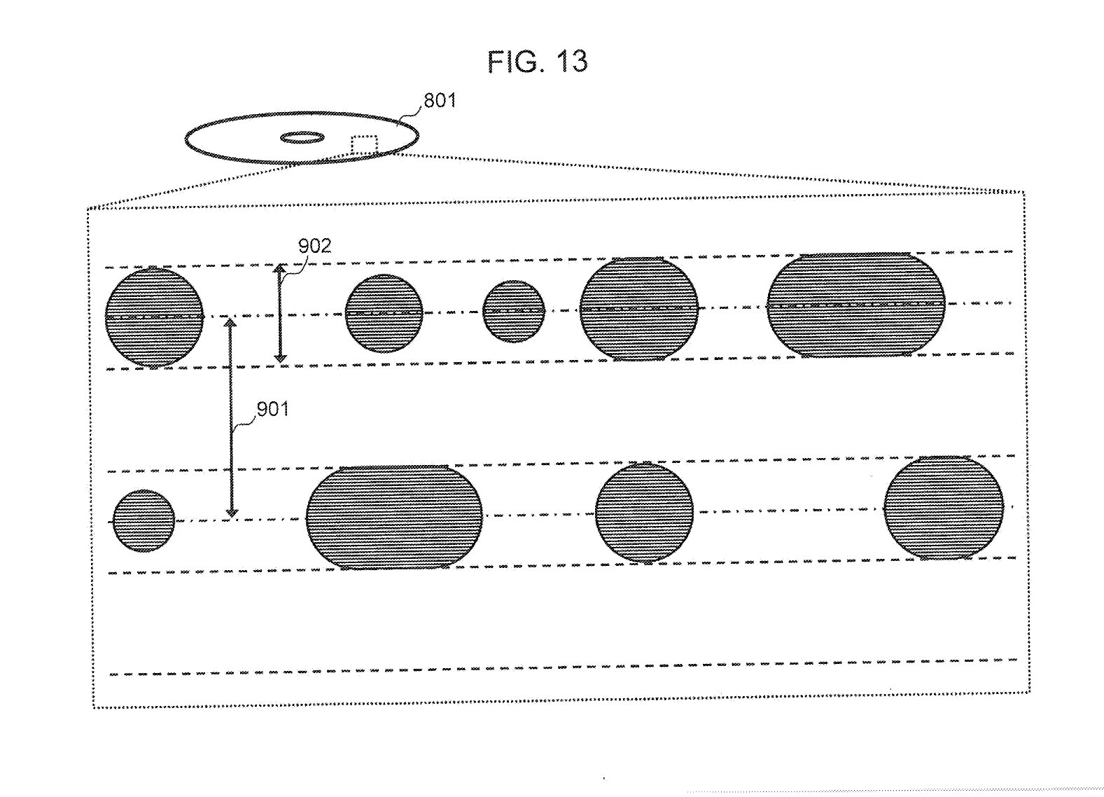

FIG. 13 is an enlarged view of a part of the recording surface of the optical information recording medium 801. In this embodiment, the track pitch 901 is 317.5 nm, for example, and the groove width 902 is 158.75 nm, for example. The length of one channel clock is 27.5 nm, for example, the shortest recording mark is 2T, for example, and the longest recording mark is 8T, for example.

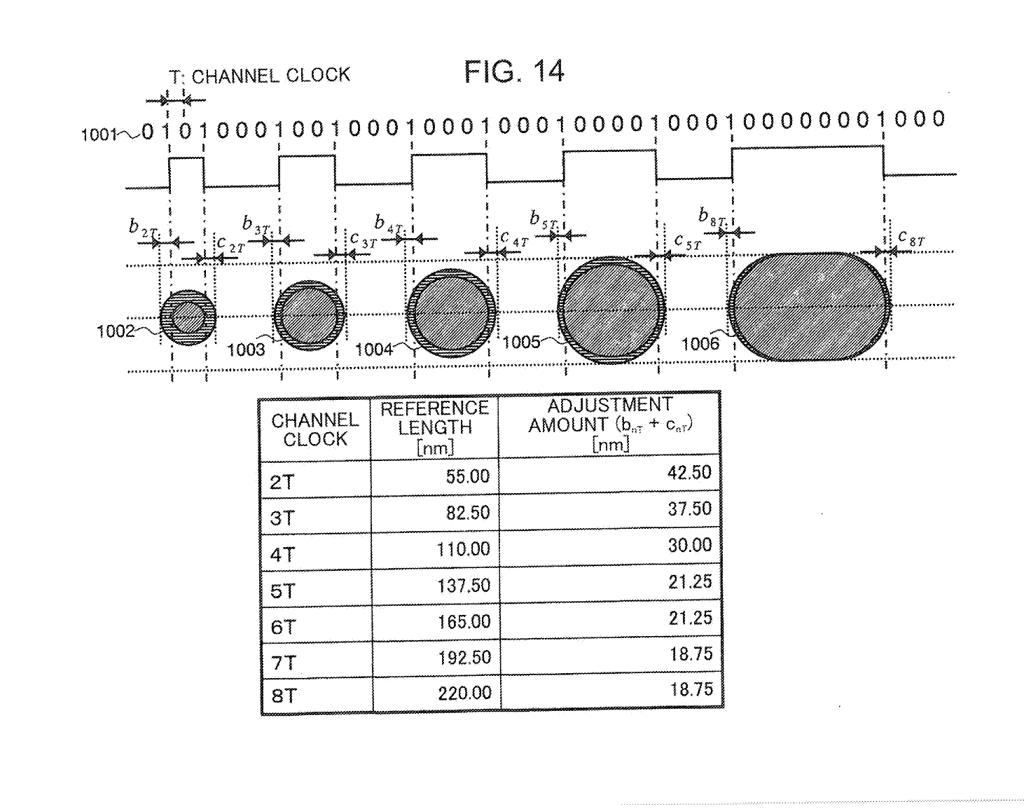

The lengths of the recording marks generated on the optical information recording medium 801 according to this embodiment will be described with reference to FIG. 14.

FIG. 14 is a diagram for explaining the lengths of the record marks generated on the optical information recording medium according to Embodiment 3 of the present invention.

In FIG. 14, the information 1001 is binary data for each channel clock T, and is an NRZI signal of which edge positions of a recording mark are “1”. The length nT (e.g. n=an integer in a 2 to 8 range) corresponding to the channel clock length, from “1” to “1” in the in the information 1001, is the reference length of a recording mark or a non-recording mark (space). When the adjustment amount of the nT recording mark from the reference length is b_{nT}+c_{nT}, the recording unit 810 generates the recording marks so that the adjustment amount of each recording mark satisfies the following relationships of Expressions (8) and (9).

b_{xT}+c_{xT}>b_{(x+1)T}+c_{(x+1)T} (8)

b_{yT}+c_{yT}≧b_{(y+1)T}+c_{(y+1)T} (9)

In Expressions (8) and (9), x denotes an integer in the 2 to 6 range, y denotes an integer in the 3 to 7 range, and x<y.

In other words, when x denotes an integer in the d to k−2 range, y denotes an integer in the d+1 to k−1 range, and x<y, the recording unit 810 generates the recording marks in which the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T and the length adjustment amount c_{(x+1)T} of a rear edge portion of the recording mark (x+1)T satisfy b_{xT}+c_{XT}>b_{(x+1)T}+c_{(x+1)T}, and the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT}≧b_{(y+1)T}+c_{(y+1)T}.

Particularly, by increasing the adjustment amount of a recording mark as the length of the recording mark is shorter, a reproduced signal, which maintains approximate linearity, can be acquired in reproduction.

Here “maintaining approximate linearity” refers to a state where the difference between the reproduced signal and the signal generated by adding isolated signals is small.

For example, in FIG. 4 described above, a 1T isolated signal 1105 is a signal generated by determining the average: of the difference between a front edge portion reproduced signal 1101 generated by reproducing a front edge portion of a long recording mark on which inter-symbol interference has little influence, and a front edge portion 1T shift signal 1102 generated by shifting the front edge portion reproduced signal 1101 by one channel clock; and the difference between a rear edge portion reproduced signal 1103 generated by reproducing a rear edge portion of a long recording mark on which inter-symbol interference has little influence, and a rear edge portion 1T shift signal 1104 generated by shifting the rear edge portion reproduced signal 1103 by one channel clock.

According to this configuration, the optical information recording/reproducing device increases the adjustment amount of the length of the receiving mark generated on the optical information recording medium as the length of the recording mark is shorter, therefore the reproduced signal that maintains approximate linearity can be acquired in reproduction, and high density recording in which reproduced signals with high SNR are acquired can be implemented.

In this embodiment, the NRZI signal is used as a signal that indicates the binary data, but binary data in other formats, such as an NRZ signal, may be used.

In this embodiment, information on the recording mark positions and the space positions are expressed by binary data, but the present invention is not limited to this. Multi-value data at least binary data—may be used. If the information is expressed by multi-value data, the information recorded by generating the recording marks may be converted into multi-value data by using a plurality of recording mark widths, or by changing the reflectance change amount, or by controlling the edge portions of the recording marks by using a resolution that is finer than 1T. Further, the information may be converted into multi-value data by phase modulation, where the recording mark generation position is modulated in the depth direction, that is, vertical to the light irradiation direction, and is then recorded.

This embodiment was described as the groove recording method, where the groove width 902 is approximately ½ the track pitch 901, but the present invention is not limited to this. For example, the land/groove recording method, where the groove width 902 is the same as the track pitch 901, can demonstrate the same effect as this embodiment.

In this embodiment, the track pitch 901, the groove width 902, the wavelength of the laser beam and the numerical aperture of the lens were described using concrete numeric values, but these numeric values are merely examples, and the present invention is not limited to these numeric values.

In this embodiment, the width of a recording mark, the reference length of which is longer than the width of the recording mark, is the same as the groove width 902, but the present invention is not limited to this. For example, all that is required is that at least there is one recording mark having a reference length that is shorter than a width of a recording mark, the reference length of which is longer than the width, even if the width of this recording mark is 80% or 90% of the groove width. If there are a plurality of recording marks, the reference length of which is longer than respective widths, then the average of these widths of the recording marks may be regarded as the width of a recording mark.

In this embodiment, the length of one channel clock is 27.5 nm, but the present invention is not limited to this. The length of one channel block can be, for example, a length where at least one recording mark, of which reference length is shorter than the width, exists. If the length of one channel clock changes, then the adjustment amount b_{nT}+c_{nT} also changes.

In this embodiment, each length of the recording marks and the spaces is 2T to 8T, but the present invention is not limited to this. The shortest recording mark length may be longer than 2T, such as 3T or 4T. Further, the longest recording mark length may be 8T or less, or 8T or more.

In this embodiment, recording marks having a same length are generated for each channel clock length, but the present invention is not limited to this. For example, when the space between recording marks is very small, inter-symbol interference occurs. To eliminate the influence of the inter-symbol interference, the adjustment amount of a recording mark may be changed depending on the lengths of the spaces before and after the recording mark, even if the channel clock length is the same.

In this embodiment, the recording parameters are recorded in the control information storage portion of the optical information recording medium 801 as pre-information when the optical information recording medium is manufactured at the factory, but the present invention is not limited to this. For example, regardless of the presence of pre-information, the optical information recording/reproducing device which performs the recording operation may record the recording parameters in the control information storage portion of the optical information recording medium 801. Alternatively, regardless of the presence of the control information storage portion, the recording parameters may be recorded as secondary information of the address information of the optical information recording medium, whereby a similar effect can be acquired.

In this embodiment, the optical information recording/reproducing device 800 includes the recording unit 810 and the reproducing unit 820, but may include only the recording unit 810. If the memory unit 808 has stored the recording parameters in advance, the recording operation can be performed without reproducing the recording parameters from the optical information recording medium 801. In other words, the memory unit 808 may hold recording parameters for generating the recording marks on the optical information recording medium 801. The recording unit 810 may generate the recording marks on the optical information recording medium 801 using the recording parameters held in the memory unit 808.

Expressions (7), (8) and (9) in Embodiments 1 and 2 are relational expressions on the adjustment amount of each recording mark from the reference length. The adjustment amount of the recording mark is a physical length to adjust the recording mark generated on the optical information recording medium (see FIG. 14).

As described above, in order to solve the problems of the present invention, the recording marks should be generated so as to satisfy the relationship of Expression (7) or the relationships of Expression (8) and (9). The pulse shape and the conditions of a recording pulse to generate a recording mark are not especially restricted.

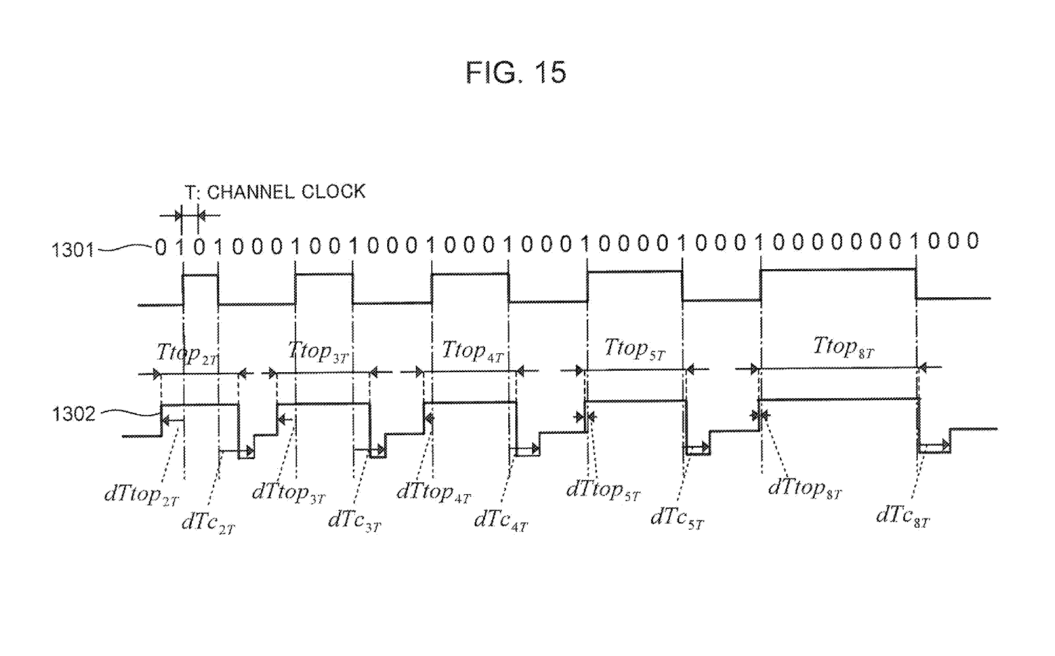

Here the recording pulse will be described in brief. FIG. 15 is a diagram depicting an example of a recording pulse for binary data.

In FIG. 15, the information 1301 is binary data for each channel clock T, and is an NRZI signal of which each edge position of a recording mark is “1”. The length nT (e.g. n=an integer in a 2 to 8 range) corresponding to the channel clock length from “1” to “1” in the information 1301 is the reference length of a recording mark or non-recording mark (space).

The recording pulse 1302 is laser output for generating recording marks. The recording pulse 1302 is set for each recording mark corresponding to the NRZI signal.

The recording marks on the optical information recording medium are normally generated by heating, or heating and cooling. In the recording pulses in FIG. 15, three recording pulse parameters dTtop, Ttop and dTc are set, and heating and cooling are performed.

dTop is a recording pulse parameter for setting the reference position to the heating start position. Ttop is a recording pulse parameter for setting heating time, and dTc is a recording pulse parameter for setting the cooling time from the reference position.

In FIG. 15, the reference position of dTtop is a rise position of the NRZI signal, and the reference position of dTc is a fall position of the NRZI signal. The reference position of dTtop or dTc, however, is not limited to this. For example, the reference position of dTtop may be a position behind the rise position of the NRZI signal by 1T length. The reference position of dTc may be a position ahead of the fall portion of the NRZI signal by 1T length.

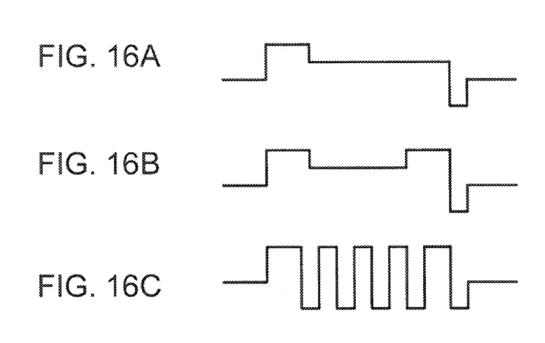

The recording pulse 1302 in FIG. 15 is a monopulse. The recording pulse 1302 may be one of the recording pulses shown in FIG. 16A to FIG. 16C, instead of the monopulse. FIG. 16A is an example of a pulse waveform when the recording pulse is an L-type pulse, FIG. 16B is an example of a pulse waveform when the recording pulse is a castle-type pulse, and FIG. 16C is an example of a pulse waveform when the recording pulse is a multi-pulse. To set a recording pulse, a recording pulse suitable for the recording characteristic of the optical information recording medium is selected. Therefore a different recording pulse may be set according to the length of the recording mark. For example, the monopulse is set for a 2T recording mark, the L-type pulse is set for the 3T recording mark, and the castle-type pulse is set for 4T or longer recording marks.

In FIG. 15, Ttop_{2T} denotes Ttop corresponding to the 2T recording mark, dTtop_{2T} denotes dTtop corresponding to the 2T recording mark, and dTc_{2T} denotes dTc corresponding to the 2T recording marks. The other recording marks are also denoted in the same manner.

In this way, the recording pulse parameters Ttop, dTtop and dTc are set for each recording mark, and each recording mark is generated so as to satisfy the relationship of Expression (7) or the relationships of Expressions (8) and (9).

The recording pulse parameter Ttop having each channel clock length is set so as to satisfy the relationship of the following Expression (10), for example.

Ttop_{2T}/2>Ttop_{3T}/3>Ttop_{4T}/4≧Ttop_{nT}/n (n: a 5 or greater integer) (10)

If Expression (10) is satisfied, the relationship of Expression (7) or the relationships of Expressions (8) and (9) can be satisfied for an optical information recording medium, on which the lengths of the recording marks change according to the set value of Ttop. In Expression (10), Ttop is divided by the length, because the comparison is based on the unit length, without depending on the length of the recording mark.

The recording pulse parameter dTtop of each channel clock length is set to satisfy the relationship of Expression (11), for example.

dTtop_{2T}>dTtop_{3T}>dTtop_{4T}≧dTtop_{nT} (n: a 5 or greater integer) (11)

If Expression (11) is satisfied, the relationship of Expression (7) or the relationships of Expressions (8) and (9) can be satisfied for an optical information recording medium, on which the start position of each recording mark changes depending on the set value of dTtop, and the end position of each recording mark comes to the same position.

Further, the recording pulse parameter dTc of each channel clock length is set to satisfy the relationship of Expression (12), for example.

dTc_{2T}>dTc_{3T}>dTc_{4T}≧dTc_{nT} (n: a 5 or greater integer) (12)

If Expression (12) is satisfied, the relationship of Expression (7), or the relationships of Expressions (8) and (9) can be satisfied for an optical information recording medium, on which the end position of each recording mark changes depending on the set value of dTc, and the start position of each recording mark comes to the same position.

When a different recording pulse is set according to the length of the recording mark, in other words, when 2T to 4T recording marks are generated as monopulses, and 5T or longer recording marks are generated as castle-type pulses, for example, the recording pulse parameters in the channel clock length range (e.g. 2T to 4T) where a same recording pulse is set may be set by one of Expression (10), Expression (11) and Expression (12).

Even if the shapes of recording pulses are different, the recording time at a same power level may be converted into the recording time per unit length, normalized by the length of the recording mark, then recording conditions to satisfy the relationship of Expression (7) or the relationships of Expressions (8) and (9) may be set.

In other words, when W_{nT} denotes the recording time per unit length at a recording pulse for generating the nT recording mark, p denotes an integer in the d to k−2 range, q denotes an integer in the d+1 to k−1 range, and p<q, the recording time W_{pT} per unit length at a recording pulse for generating a recording mark pT and the recording time W_{(p+1)T} per unit length at a recording pulse for generating a recording mark (p+1)T satisfy W_{pT}>W_{(p+1)T}, and the recording time W_{qT} per unit length at a recording pulse for generating a recording mark qT and recording time W_{(q+1)T} per unit length at a recording pulse for generating a recording mark (q+1)T satisfy W_{qT}≧W_{(q+1)T}.

By setting recording pulses suitable for the recording characteristic of the optical information recording medium, the recording marks that satisfy the relationship of Expression (7) or the relationships of Expressions (8) and (9) can be generated.

Expressions (8) and (9) are relational expressions on the length of recording marks. For the positions (phases) of the recording marks, it is more preferable to satisfy the following Expression (13).

b_{2T}−c_{2T}=b_{3T}−c_{3T}=b_{4T}−c_{4T}=b_{long}−c_{long} (13)

If the relationship of Expression (13) is satisfied, the center position of each recording mark becomes relatively the same. In other words, there is no positional deviation in each recording mark, so reproduced signals with minimal errors can be acquired.

The above described embodiments primarily include the invention having the following configurations.

An optical information recording medium according to an aspect of the invention is an optical information recording medium configured to record information by generating a plurality of recording marks having various lengths, wherein when b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n and k denotes a maximum value of n, the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT and the length adjustment amount c_{kT} of a rear edge portion of the longest recording mark dT satisfy b_{dT}+c_{dT}>b_{kT}+c_{kT}.

According to this configuration, the sum of the length adjustment amount b_{dT} of the front edge portion and the length adjustment amount c_{dT} of the rear edge portion of the shortest recording mark dT is greater than the sum of the length adjustment amount b_{kT} of the front edge portion of the longest recording mark kT and the length adjustment amount c_{kT} of the rear edge portion of the longest recording mark dT, therefore the reproduced signal that maintains approximate linearity can be acquired in reproduction, and a reproduced signal having high SNR with minimum reproduction distortion can be acquired. As a result, the recording marks can be generated at high density.

In this optical information recording medium, it is preferable that when x denotes an integer in the d to k−2 range, y denotes an integer in the d+1 to k−1 range, and x<y, the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T and the length adjustment amount c_{(x+1)T} of a rear edge portion of the recording mark (x+1)T satisfy b_{xT}+c_{xT}>b_{(x+1)T}+c_{(x+1)T}, and the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT} b_{(y+1)T}+c_{(y+1)T}.

According to this configuration, the adjustment amount is increased as the length of the recording mark is shorter, therefore the reproduced signal that maintains approximate linearity can be acquired in reproduction, and a high density recording in which reproduced signals with high SNR are acquired can be implemented.

In this optical information recording medium, it is preferable that when λ denotes the wavelength of a laser beam for reading information from the optical information recording medium, and NA denotes a numerical aperture of a lens for condensing the laser beam onto the optical information recording medium, the plurality of recording marks include a recording mark that is shorter than λ/(4×NA).

According to this configuration, the plurality of recording marks include a recording mark that is shorter than λ/(4×NA), therefore in a high density recording including recording marks shorter than the MTF cur-off frequency, reproduction distortion is minimized, and a large capacity information recording with less errors can be implemented.

In this optical information recording medium, it is preferable that when W_{nT} denotes the recording time per unit length at a recording pulse for generating the nT recording mark, p denotes an integer in the d to k−2 range, q denotes an integer in the d+1 to k−1 range, and p<q is established, the recording time W_{pT} per unit length at a recording pulse for generating a recording mark pT and the recording time W_{(p+1)T} per unit length at a recording pulse for generating a recording mark (p+1)T satisfy W_{pT}>W_{(p+1)T}, and the recording time W_{qT} per unit length at a recording pulse for generating a recording mark qT and recording time W_{(q+1)T} per unit length at a recording pulse for generating a recording mark (q+1)T satisfy W_{qT}≧W_{(q+1)T}.

According to this configuration, the recording time W_{pT} per unit length at the recording pulse for generating the recording mark pT and the recording time W_{(p+1)T} per unit length at the recording pulse for generating the recording mark (p+1)T satisfy W_{pT}>W_{(p+1)T}, and the recording time W_{qT} per unit length at the recording pulse for generating the recording mark qT and the recording time W_{(q+1)T} per unit length at the recording pulse for generating the recording mark (q+1)T satisfy W_{qT}≧W_{(q+1)T}, therefore a recording mark of which adjustment amount is larger as the length of the recording mark is shorter can be generated.

An optical information recording medium according to another aspect of the invention is an optical information recording medium configured to record information by generating a plurality of recording marks having various lengths, wherein the optical information recording medium includes a control information storage portion that stores recording parameters, and when b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n, and k denotes a maximum value of n, the recording parameters includes recording parameters for generating recording marks in which the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT, and the length adjustment amount c_{kT} of a rear edge portion of the longest recording mark dT satisfy b_{dT}+c_{dT}>b_{kT}+c_{kT}.

According to this configuration, the sum of the length adjustment amount b_{dT} of the front edge portio and the length adjustment amount c_{dT} of the rear edge portion of the shortest recording mark dT is greater than the sum of the length adjustment amount b_{kT} of the front edge portion n of the longest recording mark kT and the length adjustment amount c_{kT} of the rear edge portion of the longest recording mark dT, therefore the reproduced signal that maintains approximate linearity can be acquired in reproduction, and a reproduced signal having high SNR with minimum reproduction distortion can be acquired. As a result, the recording marks can be generated at high density.

In this optical information recording medium, it is preferable that when x denotes an integer in the d to k−2 range, y denotes an integer in the d+1 to k−1 range, and x<y is established, the recording parameters include recording parameters for generating recording marks in which the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T, and the length adjustment amount c_{(x+1)T} of a rear edge portion of the recording mark (x+1)T satisfy b_{xT}+c_{xT}>b_{(x+1)T}+c_{(x+1)T}, and the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT} b_{(y+1)T}+c_{(y+1)T}.

According to this configuration, the adjustment amount is increased as the length of the recording mark is shorter, therefore the reproduced signal that maintains approximate linearity can be acquired in reproduction, and a high density recording in which reproduced signals with high SNR are acquired can be implemented.

In this optical information recording medium, it is preferable that when λ denotes the wavelength of a laser beam for reading information from the optical information recording medium, and NA denotes a numerical aperture of a lens for condensing the laser beam onto the optical information recording medium, the plurality of recording marks include a recording mark that is shorter than λ/(4×NA).

According to this configuration, the plurality of recording marks include a recording mark that is shorter than λ/(4×NA), therefore in a high density recording including recording marks shorter than the MTF cur-off frequency, reproduction distortion is minimized, and a large capacity information recording with less errors can be implemented.

In this optical information recording medium, it is preferable that when W_{nT} denotes the recording time per unit length at a recording pulse for generating the nT recording mark, p denotes an integer in the d to k−2 range, q denotes an integer in the d+1 to k−1 range, and p<q is established, the recording time W_{pT} per unit length at a recording pulse for generating a recording mark pT and the recording time W_{(p+1)T} per unit length at a recording pulse for generating a recording mark (p+1)T satisfy W_{pT}>W_{(p+1)T}, and recording time W_{qT} per unit length at a recording pulse for generating a recording mark qT and recording time W_{(q+1)T} per unit length at a recording pulse for generating a recording mark (q+1)T satisfy W_{qT}≧W_{(q+1)T}.

According to this configuration, the recording time W_{pT} per unit length at the recording pulse for generating the recording mark pT and the recording time W_{(p+1)T} per unit length at the recording pulse for generating the recording mark (p+1)T satisfy W_{pT}>W_{(p+1)T}, and the recording time W_{qT} per unit length at the recording pulse for generating the recording mark qT and the recording time W_{(q+1)T} per unit length at the recording pulse for generating the recording mark (q+1)T satisfy W_{qT}≧W_{(q+1)T}, therefore a recording mark of which adjustment amount is larger as the length of the recording mark is shorter can be generated.

An optical information recording device according to another aspect of the present invention is an optical information recording device configured to record information by generating a plurality of recording marks having various lengths on an optical information recording medium, the optical information recording device comprising: a light source that emits a laser beam; a lens that condenses the laser beam onto the optical information recording medium; and a recording unit that generates recording marks on the optical information recording medium, wherein when b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n and k denotes a maximum value of n, the recording unit generates the recording marks in which the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT and the length adjustment amount c_{kT} of a rear edge portion of the longest recording mark dT satisfy b_{dT}+c_{dT}>b_{kT}+c_{kT}.

According to this configuration, the sum of the length adjustment amount b_{dT} of the front edge portion and the length adjustment amount c_{dT} of the rear edge portion of the shortest recording mark dT is greater than the sum of the length adjustment amount b_{kT} of the front edge portion and the length adjustment amount c_{kT} of the rear edge portion of the longest recording mark kT, therefore the reproduced signal that maintains approximate linearity can be acquired in reproduction, and a reproduced signal having high SNR with minimum reproduction distortion can be acquired. As a result, the recording marks can be generated at high density.

In this optical information recording device, it is preferable that when x denotes an integer in the d to k−2 range, y denotes an integer in the d+1 to k−1 range, and x<y is established, the recording unit generates the recording marks in which the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T and the length adjustment amount c_{(x+1)T} of a rear edge portion of the recording mark (x+1)T satisfy b_{xT}+c_{XT}>b_{(x+1)T}+c_{(x+1)T}, and the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT} b_{(y+1)T}+c_{(y+1)T}.

According to this configuration, the adjustment amount is increased as the length of the recording mark is shorter, therefore the reproduced signal that maintains approximate linearity can be acquired in reproduction, and a high density recording in which reproduced signals with high SNR are acquired can be implemented.

It is preferable that this optical information recording device further includes a reproducing unit that reproduces recording parameters, which are used for generating the recording marks on the optical information recording medium, from this optica information recording medium, wherein the recording unit generates the recording marks on the optical information recording medium, using the recording parameters reproduced by the reproducing unit.

According to this configuration, the recording parameters for generating recording marks on the optical information recording medium are reproduced from this optical information recording medium, therefore recording parameters are set according to the reproduced optical information recording medium, whereby the recording marks can be formed on the optical information recording medium.

It is preferable that this optical information recording device further includes a memory unit that holds recording parameters for generating the recording marks on the optical information recording medium, wherein the recording unit generates the recording marks on the optical information recording medium, using the recording parameters held in the memory unit.

According to this configuration, the recording parameters for generating the recording marks on the optical information recording medium are held in the memory unit, therefore the recording marks can be generated on the optical information recording medium without reproducing the recording parameters from the optical information recording medium.

In this optical information recording device, it is preferable that when λ denotes the wavelength of a laser beam emitted from the light source, and NA denotes a numerical aperture of the lens, the plurality of recording marks include a recording mark that is shorter than λ/(4×NA).

According to this configuration, the plurality of recording marks include a recording mark that is shorter than λ/(4×NA), therefore in a high density recording including recording marks shorter than the MTF cur-off frequency, reproduction distortion is minimized, and a large capacity information recording with less errors can be implemented.

In this optical information recording device, it is preferable that when W_{nT} denotes the recording time per unit length at a recording pulse for generating the nT recording mark, p denotes an integer in the d to k−2 range, q denotes an integer in the d+1 to k−1 range, and p<q is established, the recording unit generates the recording marks in which the recording time W_{pT} per unit length at a recording pulse for generating a recording mark pT and the recording time W_{(p+1)T} per unit length at a recording pulse for generating a recording mark (p+1)T satisfy W_{pT}>W_{(p+1)T}, and recording time W_{qT} per unit length at a recording pulse for generating a recording mark qT and recording time W_{(q+1)T} per unit length at a recording pulse for generating a recording mark (q+1)T satisfy W_{qT}≧W_{(q+1)T}.

According to this configuration, the recording time W_{pT} per unit length at the recording pulse for generating the recording mark pT and the recording time W_{(p+1)T} per unit length at the recording pulse for generating the recording mark (p+1)T satisfy W_{pT}>W_{(p+1)T}, and the recording time W_{qT} per unit length at the recording pulse for generating the recording mark qT and the recording time W_{(q+1)T} per unit length at the recording pulse for generating the recording mark (q+1)T satisfy W_{qT}≧W_{(q+1)T}, therefore a recording mark of which adjustment amount is larger as the length of the recording mark is shorter can be generated.

The embodiments and examples described in the “Description of Embodiments” section are for clarifying the technical content of the present invention, and should not limit the invention to these embodiments or be used to interpret the invention in a narrow way. The present invention can be carried out with various changes and modifications within the true spirit of the invention and scope of the Claims.

### INDUSTRIAL APPLICABILITY

The optical information recording medium and the optical information recording device according to the present invention can generate recording marks at high density, and can generate a plurality of recording marks having various lengths, therefore are useful for an optical information recording medium and an optical information recording device for recording information.

1-14. (canceled)

15. An optical information recording medium configured to record information by generating a plurality of recording marks having various lengths, wherein
when b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n and k denotes a maximum value of n,
the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT and the length adjustment amount c_{kT} of a rear edge portion of the longest recording mark kT satisfy b_{dT}+c_{dT}>b_{kT}+c_{kT} and
a width of the shortest recording mark dT is smaller than a width of the longest recording mark kT.

16. The optical information recording medium according to claim 15, wherein
when x denotes an integer in the d to k−2 range, y denotes an integer in the d+1 to k−1 range, and x<y is established, the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T and the length adjustment amount c_{(x+1)T} of a rear edge portion of the recording mark (x+1)T satisfy b_{xT}+c_{xT}>b_{(x+1)T}+c_{(x+1)T}, and
the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT}≧b_{(y+1)T}+c_{(y+1)T}.

17. The optical information recording medium according to claim 15, wherein
when λ denotes the wavelength of a laser beam for reading information from the optical information recording medium, and NA denotes a numerical aperture of a lens for condensing the laser beam onto the optical information recording medium,
the plurality of recording marks include a recording mark that is shorter than λ/(4×NA).

18. The optical information recording medium according to claim 15, wherein
when W_{nT} denotes the recording time per unit length at a recording pulse for generating the nT recording mark, p denotes an integer in the d to k−2 range, q denotes an integer in the d+1 to k−1 range, and p<q is established,
the recording time W_{pT} per unit length at a recording pulse for generating a recording mark pT and the recording time W_{(p+1)T} per unit length at a recording pulse for generating a recording mark (p+1)T satisfy W_{pT}>W_{(p+1)T}, and the recording time W_{qT} per unit length at a recording pulse for generating a recording mark qT and recording time W_{(q+1)T} per unit length at a recording pulse for generating a recording mark (q+1)T satisfy W_{qT}≧W_{(q+1)T}.

19. An optical information recording medium configured to record information by generating a plurality of recording marks having various lengths, wherein
the optical information recording medium includes a control information storage portion that stores recording parameters, and
when b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n, and k denotes a maximum value of n,
the recording parameters includes recording parameters for generating recording marks in which the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT, and the length adjustment amount c_{kT} of a rear edge portion of the longest recording mark kT satisfy b_{dT}+c_{dT}>b_{kT}+c_{kT}, and a width of the shortest recording mark dT is smaller than a width of the longest recording mark kT.

20. The optical information recording medium according to claim 19, wherein
when x denotes an integer in the d to k−2 range, y denotes an integer in the d+1 to k−1 range, and x<y is established,
the recording parameters include recording parameters for generating recording marks in which the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T, and the length adjustment amount c_{(x+1)T} of a rear edge portion of the recording mark (x+1)T satisfy b_{xT}+c_{xT}>b_{(x+1)T}+c_{(x+1)T}, and the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT} b_{(y+1)T}+c_{(y+1)T}.

21. The optical information recording medium according to claim 19, wherein
when λ denotes the wavelength of a laser beam for reading information from the optical information recording medium, and NA denotes a numerical aperture of a lens for condensing the laser beam onto the optical information recording medium,
the plurality of recording marks include a recording mark that is shorter than λ/(4×NA).

22. The optical information recording medium according to claim 19, wherein
when W_{nT} denotes the recording time per unit length at a recording pulse for generating the nT recording mark, p denotes an integer in the d to k−2 range, q denotes an integer in the d+1 to k−1 range, and p<q is established,
the recording time W_{pT} per unit length at a recording pulse for generating a recording mark pT and the recording time W_{(p+1)T} per unit length at a recording pulse for generating a recording mark (p+1)T satisfy W_{pT}>W_{(p+1)T}, and
recording time W_{qT} per unit length at a recording pulse for generating a recording mark qT and recording time W_{(q+1)T} per unit length at a recording pulse for generating a recording mark (q+1)T satisfy W_{qT}≧W_{(q+1)T}.

23. An optical information recording device configured to record information by generating a plurality of recording marks having various lengths on an optical information recording medium,
the optical information recording device comprising:
a light source that emits a laser beam;
a lens that condenses the laser beam onto the optical information recording medium; and
a recording unit that generates recording marks on the optical information recording medium, wherein
when b_{nT} denotes the length adjustment amount of a front edge portion of an nT recording mark (n: integer, T: channel clock length) and c_{nT} denotes the length adjustment amount of a rear edge portion thereof with respect to a channel clock reference, d denotes a minimum value of n and k denotes a maximum value of n,
the recording unit generates the recording marks in which the length adjustment amount b_{dT} of a front edge portion of a shortest recording mark dT, the length adjustment amount c_{dT} of a rear edge portion of the shortest recording mark dT, the length adjustment amount b_{kT} of a front edge portion of a longest recording mark kT and the length adjustment amount c_{kT} of a rear edge portion of the longest recording mark kT satisfy b_{dT}+c_{dT}>b_{kT}+c_{kT}, and a width of the shortest recording mark dT is smaller than a width of the longest recording mark kT.

24. The optical information recording device according to claim 23, wherein
when x denotes an integer in the d to k−2 range, y denotes an integer in the d+1 to k−1 range, and x<y is established, the recording unit generates the recording marks in which the length adjustment amount b_{xT} of a front edge portion of a recording mark xT, the length adjustment amount c_{xT} of a rear edge portion of the recording mark xT, the length adjustment amount b_{(x+1)T} of a front edge portion of a recording mark (x+1)T and the length adjustment amount c_{(x+1)T} of a rear edge portion of the recording mark (x+1)T satisfy b_{xT}+c_{xT}>b_{(x+1)T}+c_{(x+1)T}, and the length adjustment amount b_{yT} of a front edge portion of a recording mark yT, the length adjustment amount c_{yT} of a rear edge portion of the recording mark yT, the length adjustment amount b_{(y+1)T} of a front edge portion of a recording mark (y+1)T and the length adjustment amount c_{(y+1)T} of a rear edge portion of the recording mark (y+1)T satisfy b_{yT}+c_{yT} b_{(y+1)T}+c_{(y+1)T}.

25. The optical information recording device according to claim 23, further comprising a reproducing unit that reproduces recording parameters, which are used for generating the recording marks on the optical information recording medium, from the optical information recording medium, wherein
the recording unit generates the recording marks on the optical information recording medium, using the recording parameters reproduced by the reproducing unit.

26. The optical information recording device according to claim 23, further comprising a memory unit that holds recording parameters for generating the recording marks on the optical information recording medium, wherein
the recording unit generates the recording marks on the optical information recording medium, using the recording parameters held in the memory unit.

27. The optical information recording device according to claim 23, wherein
when λ denotes the wavelength of a laser beam emitted from the light source, and NA denotes a numerical aperture of the lens,
the plurality of recording marks include a recording mark that is shorter than λ/(4×NA).

28. The optical information recording device according to claim 23, wherein
when W_{nT} denotes the recording time per unit length at a recording pulse for generating the nT recording mark, p denotes an integer in the d to k−2 range, q denotes an integer in the d+1 to k−1 range, and p<q is established,
the recording unit generates the recording marks in which the recording time W_{pT} per unit length at a recording pulse for generating a recording mark pT and the recording time W_{(p+1)T} per unit length at a recording pulse for generating a recording mark (p+1)T satisfy W_{pT}>W_{(p+1)T}, and
recording time W_{qT} per unit length at a recording pulse for generating a recording mark qT and recording time W_{(q+1)T} per unit length at a recording pulse for generating a recording mark (q+1)T satisfy W_{qT}≧W_{(q+1)T}.
